(19) United States
(12) Patent Application Publication
(10) Pub. No.: US 2019/0369740 A1
(43) Pub. Date: Dec. 5, 2019

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/412,515

(22) Filed: May 15, 2019

(30) Foreign Application Priority Data
May 29, 2018 (JP) 2018-102771

(51) Int. Cl. G06F 3/01; G06F 3/0484

(52) U.S. Cl. CPC G06F 3/017; G06F 2203/04806; G06F 2203/04802; G06F 3/04845

(57) ABSTRACT

An information processing apparatus includes a detection unit that detects a motion of a target to be detected made to an image formed in midair; and a controller that controls contents of an operation on the image in accordance with a combination of a start position of the motion relative to a display region of the image and a direction of the motion.

### CROSS-REFERENCE TO RELATED APPLICATIONS

This application is based on and claims priority under 35 USC 119 from Japanese Patent Application No. 2018-102771 filed May 29, 2018.

### BACKGROUND

### (i) Technical Field

The present disclosure relates to an information processing apparatus, an information processing system, and a non-transitory computer readable medium.

### (ii) Related Art

There is a technique of recognizing that a touch operation has been made by a user in a case where a difference between a distance to a midair image displayed in midair and a distance to a user's hand measured by a distance sensor is within a predetermined range.

Japanese Unexamined Patent Application Publication No. 2017-62709 is an example of related art.

### SUMMARY

In the related art, only whether a touch operation has been made or not is detected.

Aspects of non-limiting embodiments of the present disclosure relate to a technique of distinguishing gestures of the same kind made to an image displayed in midair as different meanings in accordance with positions where start of the gestures is detected.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a detection unit that detects a motion of a target to be detected made to an image formed in midair; and a controller that controls contents of an operation on the image in accordance with a combination of a start position of the motion relative to a display region of the image and a direction of the motion.

### BRIEF DESCRIPTION OF THE DRAWINGS

An exemplary embodiment of the present disclosure will be described in detail based on the following figures, wherein:

FIG. 1 is a view for explaining an outline configuration of a midair image forming system according to a first exemplary embodiment;

FIGS. 2A and 2B illustrate a principle of a midair image forming apparatus that forms a midair image by causing light output from a display device to pass through a dedicated optical plate, and FIG. 2A illustrates a positional relationship between each member and the midair image and FIG. 2B illustrates part of a cross-sectional structure of the optical plate;

FIG. 3 illustrates a principle of a midair image forming apparatus that forms a three-dimensional image as a midair image;

FIGS. 4A and 4B illustrate a principle of a midair image forming apparatus that forms a midair image by using a micro mirror array structured such that small rectangular holes that constitute a dihedral corner reflector are arranged within a plane at regular intervals, and FIG. 4A illustrates a positional relationship between each member and the midair image and FIG. 4B is an enlarged view of part of the micro mirror array;

FIG. 5 illustrates a principle of a midair image forming apparatus that uses a beam splitter and a retroreflective sheet;

FIG. 6 illustrates a principle of a midair image forming apparatus that forms a midair image as an aggregate of plasma emitting bodies;

FIG. 7 is a view for explaining an example of a hardware configuration of an operation receiving apparatus according to the first exemplary embodiment;

FIG. 8 is a view for explaining a functional configuration of the operation receiving apparatus according to the first exemplary embodiment;

FIGS. 9A through 9C are views for explaining a position detected by a start position detection unit, and FIG. 9A illustrates a case where a right hand and a left hand are located outside a midair image (a case where the right hand and the left hand do not overlap the midair image), FIG. 9B illustrates a case where the right hand and the left hand are located in contact with an outer edge of the midair image, and FIG. 9C illustrates a case where the right hand and the left hand are located inside the midair image (a case where the right hand and the left hand overlap the midair image);

FIG. 10 is a table for explaining an example of a rule for specifying contents of an operation in a case where an application that outputs a midair image is software for drawing;

FIG. 11 is a table for explaining an example of a rule for specifying contents of an operation in a case where an application that outputs a midair image is software for document creation;

FIG. 12 is an example of a flowchart for explaining contents of processing performed by the operation receiving apparatus according to the first exemplary embodiment;

FIGS. 13A and 13B are views for explaining a specific example 1 of an operation using a gesture, and FIG. 13A illustrates a positional relationship between operating hands (a right hand and a left hand) and a midair image and FIG. 13B illustrates the midair image displayed after an operation is received;

FIGS. 14A and 14B are views for explaining a specific example 2 of an operation using a gesture, and FIG. 14A illustrates a positional relationship between operating hands (a right hand and a left hand) and a midair image and FIG. 14B illustrates the midair image displayed after an operation is received;

FIGS. 15A and 15B are views for explaining a specific example 3 of an operation using a gesture, and FIG. 15A illustrates a positional relationship between operating hands (a right hand and a left hand) and a midair image and FIG. 15B illustrates the midair image displayed after an operation is received;

FIGS. 16A and 16B are views for explaining a specific example 4 of an operation using a gesture, and FIG. 16A illustrates a positional relationship between operating hands (a right hand and a left hand) and a midair image and FIG. 16B illustrates the midair image displayed after an operation is received;

FIGS. 17A and 17B are views for explaining a specific example 5 of an operation using a gesture, and FIG. 17A illustrates a positional relationship between an operating hand (a right hand) and a midair image and FIG. 17B illustrates the midair image displayed after an operation is received;

FIGS. 18A and 18B are views for explaining a specific example 6 of an operation using a gesture, and FIG. 18A illustrates a positional relationship between an operating hand (a right hand) and a midair image and FIG. 18B illustrates the midair image displayed after an operation is received;

FIGS. 19A and 19B are views for explaining a specific example 7 of an operation using a gesture, and FIG. 19A illustrates a positional relationship between an operating hand (a right hand) and a midair image and FIG. 19B illustrates the midair image displayed after an operation is received;

FIGS. 20A and 20B are views for explaining a specific example 8 of an operation using a gesture, and FIG. 20A illustrates a positional relationship between an operating hand (a right hand) and a midair image and FIG. 20B illustrates the midair image displayed after an operation is received;

FIGS. 21A and 21B are views for explaining a specific example 9 of an operation using a gesture, and FIG. 21A illustrates a positional relationship between an operating hand (a left hand) and a midair image and FIG. 21B illustrates the midair image displayed after an operation is received;

FIGS. 22A and 22B are views for explaining a specific example 10 of an operation using a gesture, and FIG. 22A illustrates a positional relationship between an operating hand (a left hand) and a midair image and FIG. 22B illustrates the midair image displayed after an operation is received;

FIGS. 23A and 23B are views for explaining a specific example 11 of an operation using a gesture, and FIG. 23A illustrates a positional relationship between an operating hand (a left hand) and a midair image and FIG. 23B illustrates the midair image displayed after an operation is received;

FIGS. 24A and 24B are views for explaining a specific example 12 of an operation using a gesture, and FIG. 24A illustrates a positional relationship between an operating hand (a left hand) and a midair image and FIG. 24B illustrates the midair image displayed after an operation is received;

FIGS. 25A and 25B are views for explaining a specific example 13 of an operation using a gesture, and FIG. 25A illustrates a positional relationship between operating hands (a right hand and a left hand) and a midair image and FIG. 25B illustrates the midair image displayed after an operation is received;

FIGS. 26A and 26B are views for explaining a specific example 14 of an operation using a gesture, and FIG. 26A illustrates a positional relationship between operating hands (a right hand and a left hand) and a midair image and FIG. 26B illustrates the midair image displayed after an operation is received;

FIGS. 27A and 27B are views for explaining a specific example 15 of an operation using a gesture, and FIG. 27A illustrates a positional relationship between operating hands (a right hand and a left hand) and a midair image and FIG. 27B illustrates the midair image displayed after an operation is received;

FIGS. 28A and 28B are views for explaining a specific example 16 of an operation using a gesture, and FIG. 28A illustrates a positional relationship between operating hands (a right hand and a left hand) and a midair image and FIG. 28B illustrates the midair image displayed after an operation is received;

FIGS. 29A and 29B are views for explaining a specific example 17 of an operation using a gesture, and FIG. 29A illustrates a positional relationship between an operating hand (a right hand) and a midair image and FIG. 29B illustrates the midair image displayed after an operation is received;

FIGS. 30A and 30B are views for explaining a specific example 18 of an operation using a gesture, and FIG. 30A illustrates a positional relationship between an operating hand (a right hand) and a midair image and FIG. 30B illustrates the midair image displayed after an operation is received;

FIGS. 31A and 31B are views for explaining a specific example 19 of an operation using a gesture, and FIG. 31A illustrates a positional relationship between an operating hand (a right hand) and a midair image and FIG. 31B illustrates the midair image displayed after an operation is received;

FIGS. 32A and 32B are views for explaining a specific example 20 of an operation using a gesture, and FIG. 32A illustrates a positional relationship between an operating hand (a left hand) and a midair image and FIG. 32B illustrates the midair image displayed after an operation is received;

FIGS. 33A and 33B are views for explaining a specific example 21 of an operation using a gesture, and FIG. 33A illustrates a positional relationship between an operating hand (a left hand) and a midair image and FIG. 33B illustrates the midair image displayed after an operation is received;

FIGS. 34A and 34B are views for explaining a specific example 22 of an operation using a gesture, and FIG. 34A illustrates a positional relationship between an operating hand (a left hand) and a midair image and FIG. 34B illustrates the midair image displayed after an operation is received;

FIGS. 35A and 35B are views for explaining a specific example 23 of an operation using a gesture, and FIG. 35A illustrates a positional relationship between an operating hand (a right hand) and a midair image and FIG. 35B illustrates the midair image displayed after an operation is received;

FIGS. 36A and 36B are views for explaining a specific example 24 of an operation using a gesture, and FIG. 36A illustrates a positional relationship between an operating hand (a right hand) and a midair image and FIG. 36B illustrates the midair image displayed after an operation is received;

FIGS. 37A and 37B are views for explaining a specific example 25 of an operation using a gesture, and FIG. 37A illustrates a positional relationship between an operating hand (a right hand) and a midair image and FIG. 37B illustrates the midair image displayed after an operation is received;

FIGS. 38A through 38C are views for explaining a specific example 26 of an operation using a gesture, and FIG. 38A illustrates a positional relationship between an operating hand (a right hand) and a midair image, FIG. 38B illustrates an operation on the midair image, and FIG. 38C illustrates the midair image displayed after a two-stage operation is received;

FIGS. 39A through 39C are views for explaining a specific example 27 of an operation using a gesture, and FIG. 39A illustrates a positional relationship between an operating hand (a right hand) and a midair image, FIG. 39B illustrates an operation on the midair image, and FIG. 39C illustrates the midair image displayed after a two-stage operation is received;

FIGS. 40A and 40B are views for explaining a specific example 28 of an operation using a gesture, and FIG. 40A illustrates a positional relationship between an operating hand (a right hand) and a midair image and FIG. 40B illustrates the midair image displayed after an operation is received; and

FIGS. 41A through 41C are views for explaining a specific example 27 of an operation using a gesture, and FIG. 39A illustrates a positional relationship between an operating hand (a right hand) and a midair image, FIG. 39B illustrates an operation on the midair image, and FIG. 39C illustrates the midair image displayed after an operation is further received.

### DETAILED DESCRIPTION

An exemplary embodiment of the present disclosure is described with reference to the drawings.

### First Exemplary Embodiment

### Outline Configuration of Midair Display

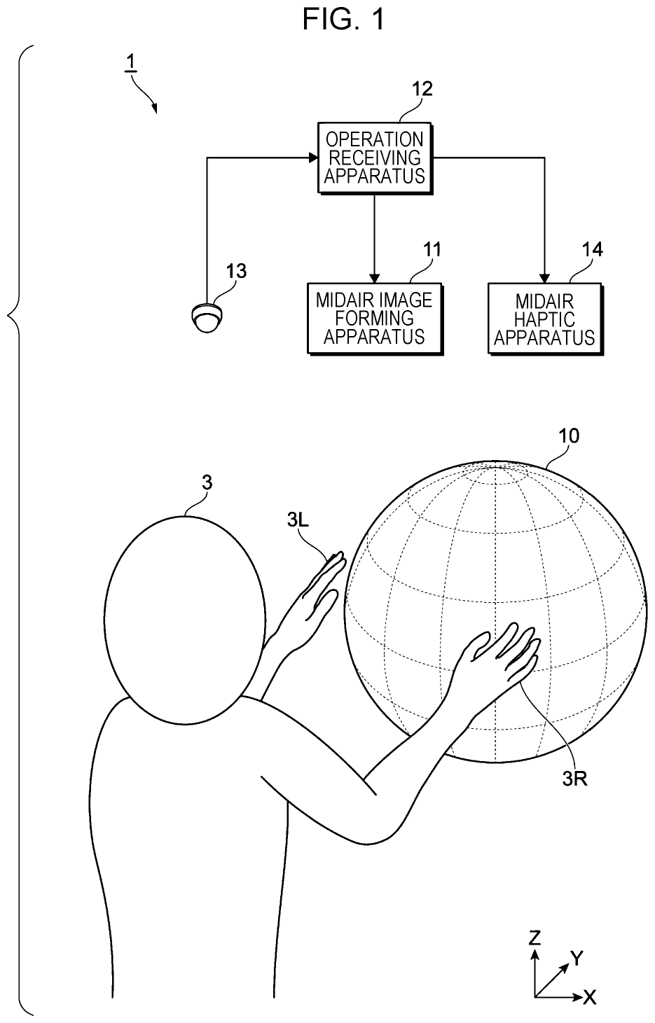

FIG. 1 is a view for explaining an outline configuration of a midair image forming system 1 according to a first exemplary embodiment.

In the present exemplary embodiment, a midair image 10 is an image formed in midair and is formed, for example, by reproducing, in midair, a state of light equivalent to light reflected by an object.

The midair image 10 is an image floating in midair, and therefore a person can pass through the midair image 10.

The midair image forming system 1 illustrated in FIG. 1 includes a midair image forming apparatus 11 that forms the midair image 10 in midair, an operation receiving apparatus 12 that detects a direction from which a person approaches the midair image 10 and receives an operation made on the midair image 10, a camera 13 that takes an image of a gesture of a user 3 made to the midair image 10, and a midair haptic apparatus 14 that gives a stimulus according to contents of the received operation to a part (e.g., a right hand 3R, a left hand 3L) of a body.

The midair image forming system 1 according to the present exemplary embodiment is an example of an information processing system, and the operation receiving apparatus 12 is an example of an information processing apparatus.

The midair image forming apparatus 11 is an example of an image forming apparatus.

The midair image 10 is one form of a display region and is used to display various kinds of information. For example, the midair image 10 is used to display a still image such as a document, a drawing, a picture, or a map, a moving image such as video, or a complex image combining a still image and a moving image. The midair image 10 is used, for example, for guide, advertisement, operation, development, learning, or the like through such display.

In FIG. 1, an outer edge (i.e., a maximum display region) of the midair image 10 is defined by a spherical shape, but a shape that defines the outer edge is not limited. For example, the outer edge of the midair image 10 may be defined by an outer edge of an object displayed as the midair image 10.

In the present exemplary embodiment, an object itself is defined as a target to be displayed or processed and is defined by an outer edge that serves as a boundary with an outer space.

An object may be defined, for example, by an outer shape of an image of a button for operation, an outer shape of an image of a person, an outer shape of an image of an animal, an outer shape of an image of a product, an outer shape of an image of a fruit, or the like.

The outer edge of the midair image 10 may be a plane or may be a stereoscopic figure such as a curved surface or a rectangular parallelepiped. In a case where the midair image 10 has a stereoscopic shape, the midair image 10 may be hollow or may have an inner structure.

In FIG. 1, the user 3 is present in front of the midair image 10 (a negative side in an X direction relative to the midair image 10) and making a gesture of touching an outer circumferential surface of the spherical midair image 10 by using the right hand 3R and the left hand 3L. The right hand 3R and the left hand 3L are an example of a target to be detected.

Since the midair image 10 is an image optically formed in midair (since there is no physical projection screen or display device), the user 3 can see a rear side of the midair image 10 and a background behind the midair image 10 through the midair image 10.

In the present exemplary embodiment, the camera 13 is located so as to be capable of detecting not only a gesture of the user 3, but also a relation between a spatial position at which the gesture starts and the midair image 10.

For example, the camera 13 is disposed above (in a positive direction of a Z axis) or below (a negative direction of the Z axis) the midair image 10 in a vertical direction. Plural cameras 13 may be disposed so as to surround the midair image 10.

A technology for measuring a distance to an object in a space or a sensor technology for detecting an object that crosses an optical detection surface may be used instead of the camera 13 or in combination with the camera 13.

As a technology for measuring a distance, the following methods may be, for example, used alone or in combination: a Time Of Flight (TOF) method for measuring a distance to an object by measuring, for each pixel, a period taken by light emitted from a semiconductor laser or a light emitting diode (LED) to return after being reflected by the object, a structure light (SL) time-series pattern projection method for measuring a distance to an object on the basis of a change in luminance appearing in a pixel of an image of the object on which a vertically-striped pattern that changes in a time-series manner is projected, a method for measuring a distance to an object by using an ultrasonic wave or a millimeter wave, and a method for measuring a distance to an object by using laser light or infrared light. Examples of a technology combined with such a technology include a technology for recognizing a gesture by processing a taken image.

### Example of Midair Image Forming Apparatus

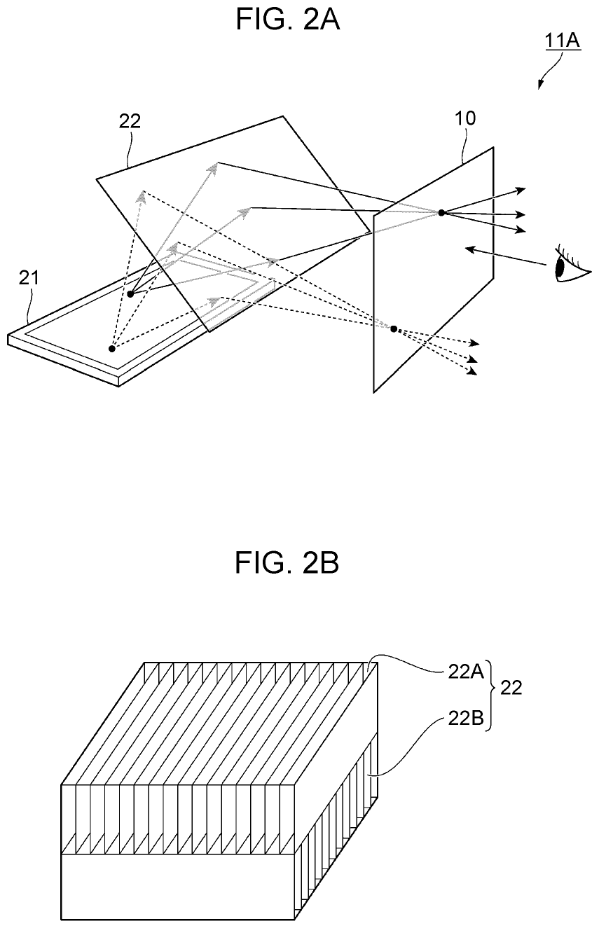

Principles of formation of the midair image 10 are described below with reference to FIGS. 2 through 6. Note that each of the principles described below is already known.

FIGS. 2A and 2B illustrate a principle of a midair image forming apparatus 11A that forms the midair image 10 by causing light output from a display device 21 to pass through a dedicated optical plate 22. FIG. 2A illustrates a positional relationship between each member and the midair image 10, and FIG. 2B illustrates part of a cross-sectional structure of the optical plate 22.

The optical plate 22 has a structure such that a plate in which glass strips 22A each having a wall surface used as a mirror are arranged and a plate in which glass strips 22B are arranged in a direction orthogonal to the glass strips 22A are vertically stacked on each other.

The optical plate 22 reproduces, in midair, an image displayed on the display device 21 by causing light output from the display device 21 to be reflected two times by the glass strips 22A and the glass strips 22B and thus forming an image in midair. A distance between the display device 21 and the optical plate 22 is identical to a distance between the optical plate 22 and the midair image 10. A dimension of the image displayed on the display device 21 is identical to a dimension of the midair image 10.

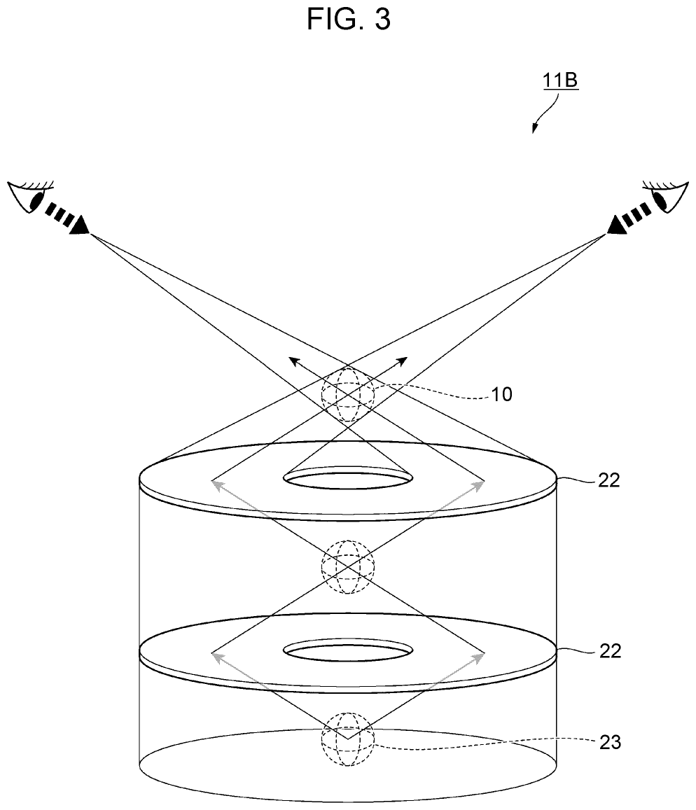

FIG. 3 illustrates a principle of a midair image forming apparatus 11B that forms a three-dimensional image as the midair image 10. The midair image forming apparatus 11B reproduces a three-dimensional image in midair by causing light reflected by a surface of an actual object 23 to pass through two ring-shaped optical plates 22. Note that the optical plates 22 need not be disposed in series.

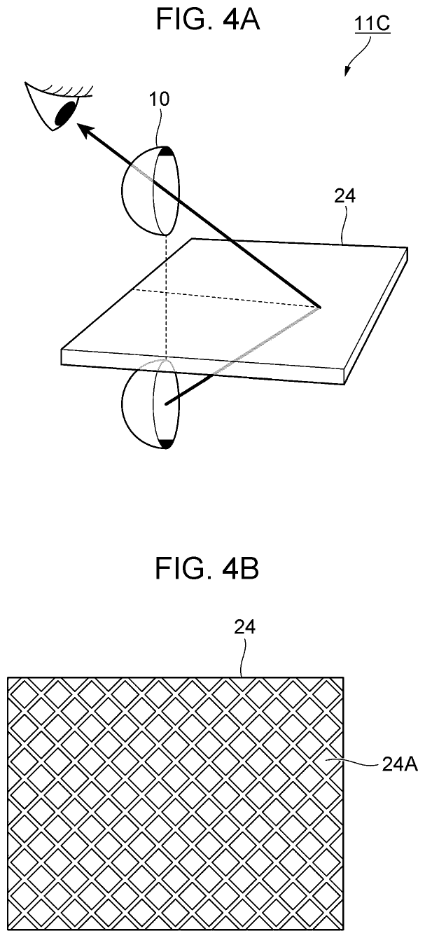

FIGS. 4A and 4B illustrate a principle of a midair image forming apparatus 11C that forms the midair image 10 by using a micro mirror array 24 structured such that small rectangular holes 24A that constitute a dihedral corner reflector are arranged within a plane at regular intervals. FIG. 4A illustrates a positional relationship between each member and the midair image 10, and FIG. 4B is an enlarged view of a part of the micro mirror array 24. Each hole 24A is, for example, 100 μm square.

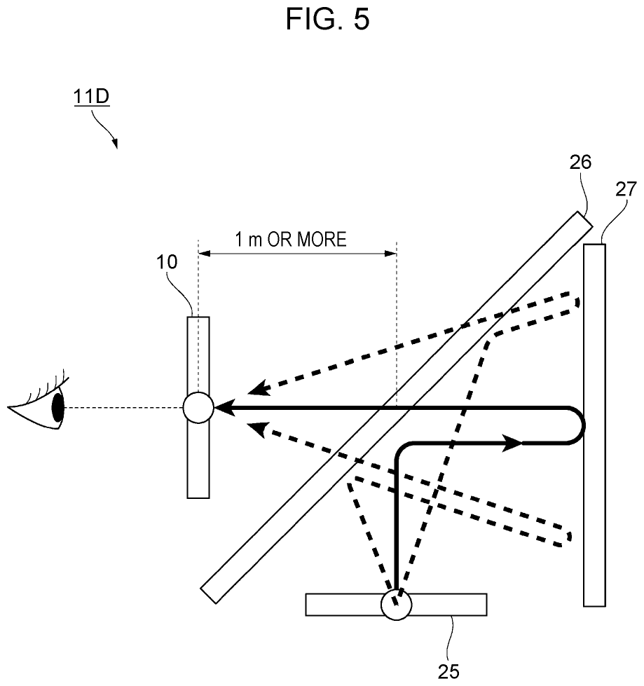

FIG. 5 illustrates a principle of a midair image forming apparatus 11D using a beam splitter 26 and a retroreflective sheet 27. The beam splitter 26 is disposed at an angle of 45 degrees with respect to a display surface of a display device 25. The retroreflective sheet 27 is disposed at an angle of 90 degrees with respect to the display surface of the display device 25 in a direction of reflection of a display image by the beam splitter 26.

In the case of the midair image forming apparatus 11D, light output from the display device 25 is reflected toward the retroreflective sheet 27 by the beam splitter 26, retro-reflected by the retroreflective sheet 27, passes through the beam splitter 26, and then forms an image in midair. The midair image 10 is formed at a position where light forms an image.

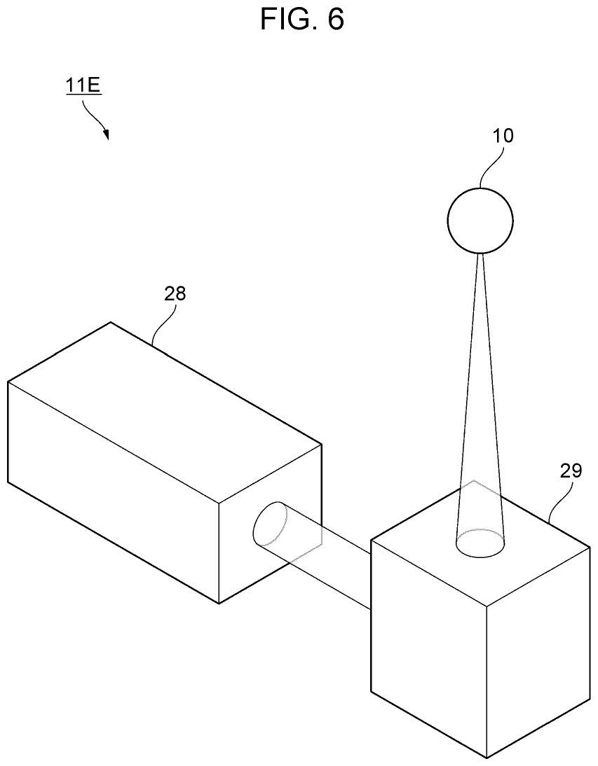

FIG. 6 illustrates a principle of a midair image forming apparatus 11E that forms the midair image 10 as an aggregate of plasma emitting bodies.

In the case of the midair image forming apparatus 11E, an infrared pulse laser 28 outputs pulsed laser light, and an XYZ scanner 29 focuses the pulsed laser light in midair. In this process, gas close to a focal point instantaneously turns into plasma and emits light.

In this case, a pulse frequency is, for example, 100 Hz or less, and a pulse emission period is, for example, a nanosecond order.

A method for generating a midair image is not limited to the methods described in FIGS. 2 through 6.

For example, a midair image may be generated by using a hologram method.

Alternatively, a method for making a user perceive as if an image is floating in midair by synthesizing light from scenery and light from a displayed image by using a transparent prism (e.g., a holographic optical element) disposed in front of the eyes of the user may be used.

Alternatively, a method for making a user wearing a head-mounted display perceive as if an image is floating in front of the user may be used.

### Configuration of Operation Receiving Apparatus 12

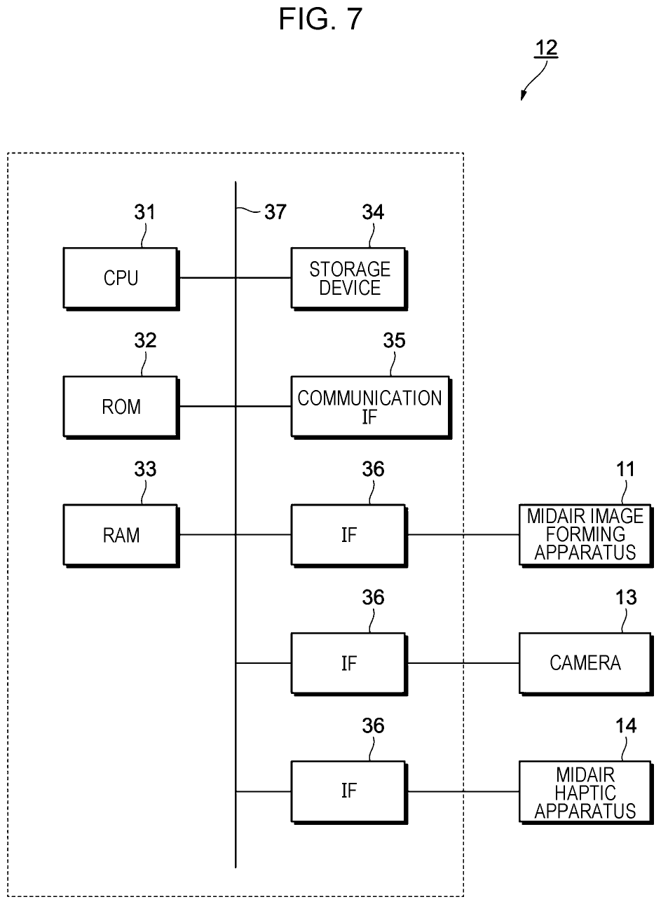

FIG. 7 is a view for explaining an example of a hardware configuration of the operation receiving apparatus 12 according to the first exemplary embodiment.

The operation receiving apparatus 12 includes a central processing unit (CPU) 31 that offers various functions through execution of firmware or an application program, a read only memory (ROM) 32 that is a storage region in which firmware and a basic input output system (BIOS) are stored, and a random access memory (RAM) 33 that is a program execution region. The CPU 31, the ROM 32, and the RAM 33 constitute a computer.

The operation receiving apparatus 12 includes a storage device 34 in which information displayed as the midair image 10 is stored. The storage device 34 is, for example, a rewritable non-volatile storage medium.

The operation receiving apparatus 12 changes contents of an image displayed as the midair image 10 in accordance with contents of an operation by controlling the midair image forming apparatus 11 by using a communication interface (communication IF) 35.

The operation receiving apparatus 12 is connected to the camera 13 that takes an image of a user's gesture and the midair haptic apparatus 14 that gives a stimulus according to contents of an operation to a part of a body through an interface (IF) 36.

The midair haptic apparatus 14 according to the present exemplary embodiment is constituted, for example, by an ultrasonic wave oscillator array in which plural ultrasonic wave oscillators are arranged in a grid manner. This kind of midair haptic apparatus 14 can generate a focal point of an ultrasonic wave at any position in midair. By adjusting a focal point distribution and a vibration strength, a sense of touch perceived by a user is changed.

The CPU 31 and each unit are connected through a bus 37.

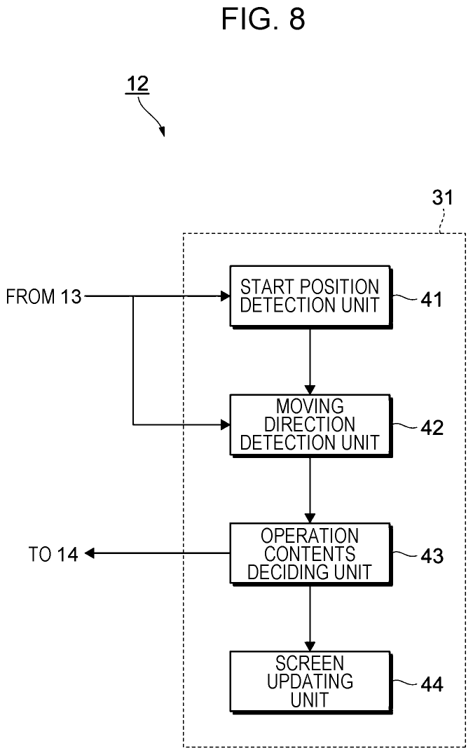

FIG. 8 is a view for explaining an example of a functional configuration of the operation receiving apparatus 12 (see FIG. 1) according to the first exemplary embodiment.

The functional configuration illustrated in FIG. 8 is realized through execution of a program by the CPU 31.

The CPU 31 functions as a start position detection unit 41 that detects a start position of a gesture made to the midair image 10 (see FIG. 1), a moving direction detection unit 42 that detects a direction in which a body part used for the gesture moves, an operation contents deciding unit 43 that decides contents of an operation on the basis of the start position of the gesture and the direction in which the body part used for the gesture moves, and a screen updating unit 44 that updates the midair image 10 (see FIG. 1) in accordance with the decided contents of the operation.

The start position detection unit 41 and the moving direction detection unit 42 are examples of a detection unit, and the operation contents deciding unit 43 is an example of a controller.

In the present exemplary embodiment, a gesture in midair is received as an operation on the midair image 10. An operation on the midair image 10 is specified by a start position of a motion and a direction of the detected motion. The start position detection unit 41 and the moving direction detection unit 42 are used to detect these pieces of information.

In the present exemplary embodiment, the start position detection unit 41 detects, as a start position of a motion, a position at which a body part (e.g., a hand or a leg) used for an operation remains still for a predetermined period or longer. The body part such as a hand, a finger, or a leg is an example of a target to be detected. A body part used as a target to be detected is set in advance in the start position detection unit 41.

A state regarded as being still need not necessarily be a state of being completely still. A state regarded as being still is defined by a program that processes an image.

A reason why a body part need remain still for a predetermined period or longer is that it is necessary to distinguish a motion of moving a body part to a start point and a motion used as an operation. In the present exemplary embodiment, a body part need remain still, for example, for two seconds.

The start position detection unit 41 detects a position of a body part (e.g., a hand) at the start of an operation as a relative relation to the midair image 10 (see FIG. 1) by processing an image taken by the camera 13.

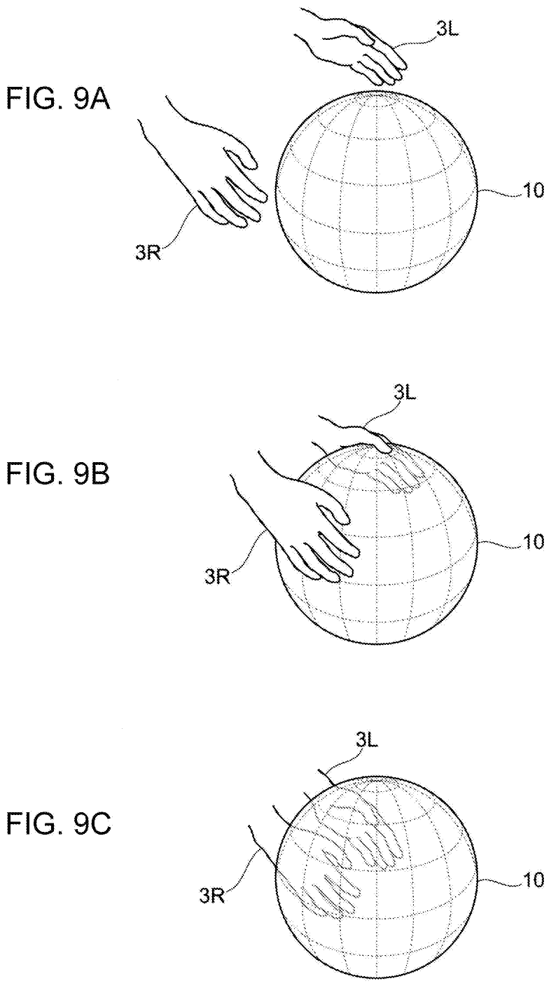

FIGS. 9A through 9C are views for explaining a position detected by the start position detection unit 41. FIG. 9A illustrates a case where the right hand 3R and the left hand 3L are located outside the midair image 10 (do not overlap the midair image 10), FIG. 9B illustrates a case where the right hand 3R and the left hand 3L are in contact with an outer edge of the midair image 10, and FIG. 9C illustrates a case where the right hand 3R and the left hand 3L are located inside the midair image 10 (overlap the midair image 10).

Contact with an outer edge does not mean strict contact.

In the present exemplary embodiment, a case where a body part used for an operation is present within a predetermined range from an outer edge of the midair image 10 is handled as a state where the body part used for an operation is in contact with the outer edge. The range includes not only an outer side of the outer deg, but also an inner side of the outer edge. A range on an outer side of the outer edge and a range on an inner side of the outer edge may be set to different values. A value of the range may be set in accordance with contents of the midair image 10.

Although FIGS. 9C through 9C illustrate a case where the positions of the right hand 3R and the left hand 3L are the same, the positions of the right hand 3R and the left hand 3L may be different. For example, the right hand 3R may be located inside the midair image 10, and the left hand 3L may be located outside the midair image 10.

Although FIGS. 9C through 9C illustrate a case where a body part used for an operation is both hands, a body part used for an operation may be a single hand, may be a finger, or may be a leg. In the present exemplary embodiment, an object such as a stick operated by a user is also handled as an equivalent to a body part used for an operation. An object such as a stick operated by a user is also an example of a target to be detected. Examples of the object may include a glove and a shoe.

The number of fingers used for an operation may be one or may be more than one. A specific finger may be handled as a part used for an operation. By specifying a part used for an operation, it is possible to make erroneous detection less frequent.

The moving direction detection unit 42 detects, as a motion related to an operation, a motion toward the midair image 10, a motion departing from the midair image 10, a motion along an outer edge, or the like. As for the motion along an outer edge, a direction in which a body part moves may be included. In a case where plural parts (e.g., both hands, plural fingers) are used for an operation, whether an interval between the plural parts narrows or widens may be detected.

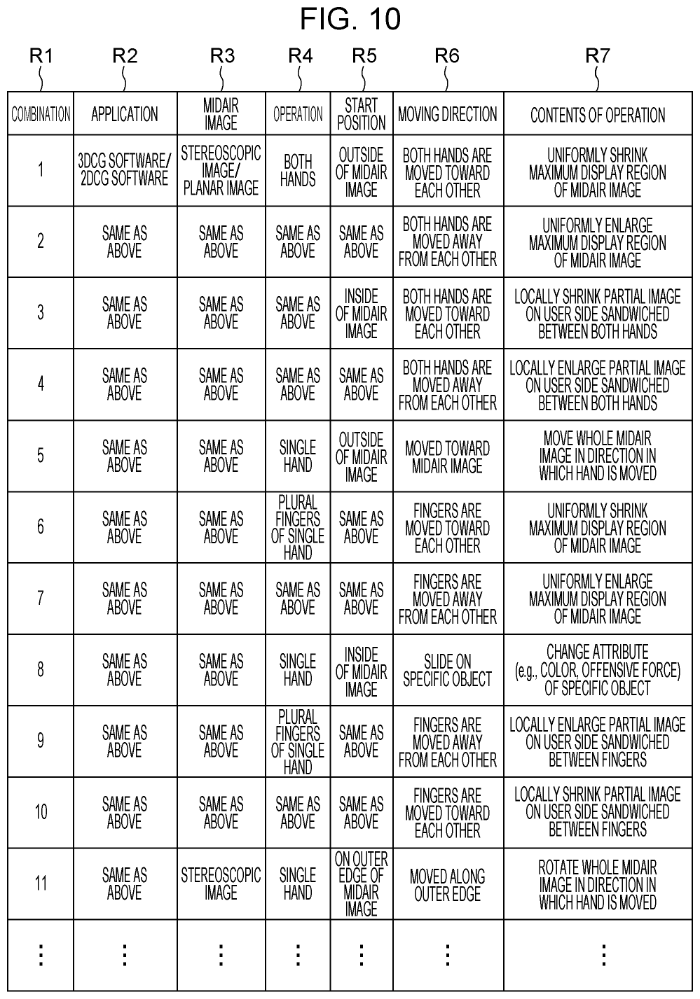

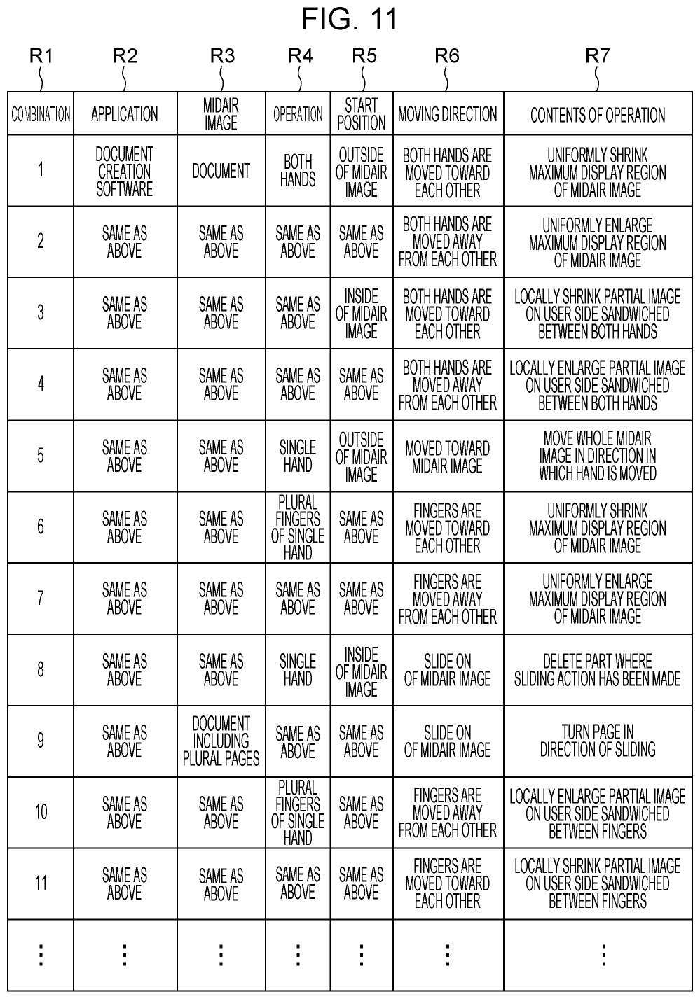

FIGS. 10 and 11 are tables illustrating an example of a rule used by the operation contents deciding unit 43 to specify contents of an operation.

FIG. 10 is a table for explaining an example of a rule used to specify contents of an operation in a case where an application that outputs the midair image 10 is software for drawing.

FIG. 11 is a table for explaining an example of a rule used to specify contents of an operation in a case where an application that outputs the midair image 10 is software for document creation.

Each of the tables illustrated in FIGS. 10 and 11 is constituted by a column R1 showing a serial number given to a combination, a column R2 showing an application that outputs the midair image 10, a column R3 showing contents displayed as the midair image 10, a column R4 showing a part used for an operation, a column R5 showing a start position, a column R6 showing a direction of a motion, and a column R7 showing contents of an operation.

First, a case (see FIG. 10) where the application is software for drawing is described.

In the case of FIG. 10, the software for drawing is three-dimensional computer graphic (3DCG) software or two-dimensional computer graphic (2DCG) software.

### Combination 1

The midair image 10 is a stereoscopic image or a planar image.

The combination 1 corresponds to a case where both hands located outside the midair image 10 (at positions that are not regarded as being contact with the midair image 10) are moved toward each other.

In this case, the user's operation is received as an operation of uniformly shrinking a maximum display region of the midair image 10.

### Combination 2

The midair image 10 is a stereoscopic image or a planar image.

The combination 2 corresponds to a case where both hands located outside the midair image 10 (at positions that are not regarded as being contact with the midair image 10) are moved away from each other.

In this case, the user's operation is received as an operation of uniformly enlarging a maximum display region of the midair image 10.

### Combination 3

The midair image 10 is a stereoscopic image or a planar image.

The combination 3 corresponds to a case where both hands located inside the midair image 10 (at positions that are not regarded as being contact with the midair image 10) are moved toward each other.

In this case, the user's operation is received as an operation of locally shrinking a partial image (a partial image on a user side in a case where the midair image 10 is a stereoscopic image) of the midair image 10 sandwiched between both hands. Meanwhile, a part of the midair image 10 that is not sandwiched by both hands is deformed so as to be enlarged in accordance with shrinking of the region.

### Combination 4

The midair image 10 is a stereoscopic image or a planar image.

The combination 4 corresponds to a case where both hands located inside the midair image 10 (at positions that are not regarded as being contact with the midair image 10) are moved away from each other.

In this case, the user's operation is received as an operation of locally enlarging a partial image (a partial image on a user side in a case where the midair image 10 is a stereoscopic image) of the midair image 10 sandwiched between both hands. Meanwhile, a part of the midair image 10 that is not sandwiched by both hands is deformed so as to shrink in accordance with enlarging of the region.

### Combination 5

The midair image 10 is a stereoscopic image or a planar image.

The combination 5 corresponds to a case where a single hand located outside the midair image 10 (at a position that is not regarded as being contact with the midair image 10) is moved toward the midair image 10.

In this case, the user's operation is received as an operation of moving the whole midair image 10 in a direction in which the hand is moved.

### Combination 6

The midair image 10 is a stereoscopic image or a planar image.

The combination 6 corresponds to a case where plural fingers (e.g., a thumb and a forefinger) of a single hand located outside the midair image 10 (at a position that is not regarded as being contact with the midair image 10) are moved toward each other.

In this case, the user's operation is received as an operation of uniformly shrinking a maximum display region of the midair image 10.

### Combination 7

The midair image 10 is a stereoscopic image or a planar image.

The combination 7 corresponds to a case where plural fingers (e.g., a thumb and a forefinger) of a single hand located outside the midair image 10 (at a position that is not regarded as being contact with the midair image 10) are moved away from each other.

In this case, the user's operation is received as an operation of uniformly enlarging a maximum display region of the midair image 10.

### Combination 8

The midair image 10 is a stereoscopic image or a planar image.

The combination 8 corresponds to a case where a single hand located inside the midair image 10 (at a position that is not regarded as being contact with the midair image 10) is moved to slide on a specific object.

In this case, the user's operation is received as an operation of changing an attribute of the specific object that constitutes a part of the midair image 10.

Examples of the attribute include a color and offensive power of an object.

### Combination 9

The midair image 10 is a stereoscopic image or a planar image.

The combination 9 corresponds to a case where plural fingers (e.g., a thumb and a forefinger) of a single hand located inside the midair image 10 (at a position that is not regarded as being contact with the midair image 10) are moved away from each other.

In this case, the user's operation is received as an operation of locally enlarging a partial image (a partial image on a user side in a case where the midair image 10 is a stereoscopic image) of the midair image 10 sandwiched between the fingers. Meanwhile, a part of the midair image 10 that is not sandwiched between the plural fingers is deformed so as to shrink in accordance with enlarging of the region.

### Combination 10

The midair image 10 is a stereoscopic image or a planar image.

The combination 10 corresponds to a case where plural fingers (e.g., a thumb and a forefinger) of a single hand located inside the midair image 10 (at a position that is not regarded as being contact with the midair image 10) are moved toward each other.

In this case, the user's operation is received as an operation of locally shrinking a partial image (a partial image on a user side in a case where the midair image 10 is a stereoscopic image) of the midair image 10 sandwiched between the fingers. Meanwhile, a part of the midair image 10 that is not sandwiched between the plural fingers is deformed so as to be enlarged in accordance with shrinking of the region.

### Combination 11

In the case of this combination, the midair image 10 is a stereoscopic image.

The combination 11 corresponds to a case where a single hand located on an outer edge of the midair image 10 (at a position that is regarded as being in contact with the midair image 10) is moved along the outer edge.

In this case, the user's operation is received as an operation of rotating the whole midair image 10 in a direction in which the hand is moved.

As described above, different combinations of a body part used for a user's operation, a start position of the operation, and a direction of a motion are received as different operations.

In the present exemplary embodiment, a gesture that does not correspond to any of the combinations 1 through 11 is not handled as an operation.

In a case where start positions of operations and directions of motions are classified according to a predetermined rule as illustrated in FIG. 10, a small difference in position and direction can be ignored.

Furthermore, by deciding combinations of operations in advance, it is possible to heighten user's predictability of contents of an operation executed by a user's gesture.

Next, a case (see FIG. 11) where the application is software for document creation is described.

### Combination 1

The midair image 10 is a document. It is assumed here that the document is displayed page by page.

The combination 1 corresponds to a case where both hands located outside the midair image 10 (at positions that are not regarded as being contact with the midair image 10) are moved toward each other.

In this case, the user's operation is received as an operation of uniformly shrinking a maximum display region of the midair image 10.

Contents of the operation are identical to the contents of the operation in the case (see FIG. 10) in which the software is software for drawing.

### Combination 2

The midair image 10 is a document.

The combination 2 corresponds to a case where both hands located outside the midair image 10 (at positions that are not regarded as being contact with the midair image 10) are moved away from each other.

In this case, the user's operation is received as an operation of uniformly enlarging a maximum display region of the midair image 10.

Contents of the operation are identical to the contents of the operation in the case (see FIG. 10) in which the software is software for drawing.

### Combination 3

The midair image 10 is a document.

The combination 3 corresponds to a case where both hands located inside the midair image 10 (at positions that are not regarded as being contact with the midair image 10) are moved toward each other.

In this case, the user's operation is received as an operation of locally shrinking a partial image (a partial image on a user side in a case where the midair image 10 is a stereoscopic image) of the midair image 10 sandwiched between both hands. Meanwhile, a part of the midair image 10 that is not sandwiched by both hands is deformed so as to be enlarged in accordance with shrinking of the region.

Contents of the operation are identical to the contents of the operation in the case (see FIG. 10) in which the software is software for drawing.

### Combination 4

The midair image 10 is a document.

The combination 4 corresponds to a case where both hands located inside the midair image 10 (at positions that are not regarded as being contact with the midair image 10) are moved away from each other.

In this case, the user's operation is received as an operation of locally enlarging a partial image (a partial image on a user side in a case where the midair image 10 is a stereoscopic image) of the midair image 10 sandwiched between both hands. Meanwhile, a part of the midair image 10 that is not sandwiched by both hands is deformed so as to shrink in accordance with enlarging of the region.

Contents of the operation are identical to the contents of the operation in the case (see FIG. 10) in which the software is software for drawing.

### Combination 5

The midair image 10 is a document. The combination 5 corresponds to a case where a single hand located outside the midair image 10 (at a position that is not regarded as being contact with the midair image 10) is moved toward the midair image 10.

In this case, the user's operation is received as an operation of moving the whole midair image 10 in a direction in which the hand is moved.

Contents of the operation are identical to the contents of the operation in the case (see FIG. 10) in which the software is software for drawing.

### Combination 6

The midair image 10 is a document.

The combination 6 corresponds to a case where plural fingers (e.g., a thumb and a forefinger) of a single hand located outside the midair image 10 (at a position that is not regarded as being contact with the midair image 10) are moved toward each other.

In this case, the user's operation is received as an operation of uniformly shrinking a maximum display region of the midair image 10.

Contents of the operation are identical to the contents of the operation in the case (see FIG. 10) in which the software is software for drawing.

### Combination 7

The midair image 10 is a document.

The combination 7 corresponds to a case where plural fingers (e.g., a thumb and a forefinger) of a single hand located outside the midair image 10 (at a position that is not regarded as being contact with the midair image 10) are moved away from each other.

In this case, the user's operation is received as an operation of uniformly enlarging a maximum display region of the midair image 10.

Contents of the operation are identical to the contents of the operation in the case (see FIG. 10) in which the software is software for drawing.

### Combination 8

The midair image 10 is a document.

The combination 8 corresponds to a case where a single hand located inside the midair image 10 (at a position that is not regarded as being contact with the midair image 10) is moved to slide on the midair image 10.

In this case, the user's operation is received as an operation of deleting an object in a part where the sliding action has been made.

Contents of the operation are different from the contents of the operation in the case (see FIG. 10) in which the software is software for drawing although the same gesture is made.

### Combination 9

The midair image 10 is a document constituted by plural pages.

The combination 9 corresponds to a case where a single hand located inside the midair image 10 (at a position that is not regarded as being contact with the midair image 10) is moved to slide on the midair image 10.

In this case, the user's operation is received as an operation of turning a page displayed as the midair image 10 in a direction of the sliding.

Contents of the operation are different from the contents of the operation in the case (see FIG. 10) in which the software is software for drawing.

### Combination 10

The midair image 10 is a document constituted by plural pages.

The combination 10 corresponds to a case where plural fingers (e.g., a thumb and a forefinger) of a single hand located inside the midair image 10 (at a position that is not regarded as being contact with the midair image 10) are moved away from each other.

In this case, the user's operation is received as an operation of locally enlarging a partial image (a partial image on a user side in a case where the midair image 10 is a stereoscopic image) of the midair image 10 sandwiched between the fingers. Meanwhile, a part of the midair image 10 that is not sandwiched between the plural fingers is deformed so as to shrink in accordance with enlarging of the region.

Contents of the operation are identical to the contents of the operation in the case (see FIG. 10) in which the software is software for drawing.

### Combination 11

The midair image 10 is a document constituted by plural pages.

The combination 11 corresponds to a case where plural fingers (e.g., a thumb and a forefinger) of a single hand located inside the midair image 10 (at a position that is not regarded as being contact with the midair image 10) are moved toward each other.

In this case, the user's operation is received as an operation of locally shrinking a partial image (a partial image on a user side in a case where the midair image 10 is a stereoscopic image) of the midair image 10 sandwiched between the fingers. Meanwhile, a part of the midair image 10 that is not sandwiched between the plural fingers is deformed so as to be enlarged in accordance with shrinking of the region.

Contents of the operation are identical to the contents of the operation in the case (see FIG. 10) in which the software is software for drawing.

As described above, even the same combination is received as different operations in a case where software that outputs the midair image 10 differs.

Needless to say, in some cases, the same combination is received as the same operation even in a case where software that outputs the midair image 10 differs.

Even in a case where the software that outputs the midair image 10 is software for drawing, a motion of sliding a single hand on an inner side of the midair image 10 may be received as deletion of an object.

On the contrary, even in a case where the software that outputs the midair image 10 is software for document creation, a motion of sliding a single hand on an inner side of the midair image 10 may be received as change of an attribute (e.g., a font, a color) of an object in a part where the sliding motion has been made.

Which of the operations is received may be switched depending on a direction of sliding. Operation Receiving Processing

Next, processing for receiving an operation on the midair image 10 (see FIG. 1) performed by the operation receiving apparatus 12 (see FIG. 1) is described.

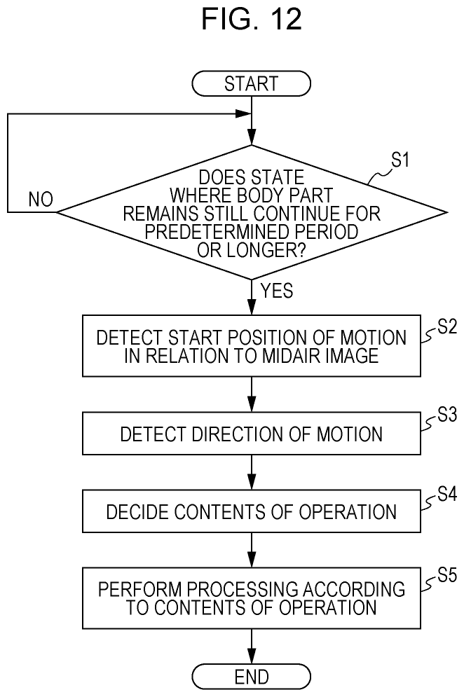

FIG. 12 is an example of a flowchart for explaining contents of processing performed by the operation receiving apparatus 12 according to the first exemplary embodiment. The contents of this processing are realized by using the functional units described with reference to FIG. 8. A specific progress of the processing is controlled through execution of a program.

In FIG. 12, each step that constitutes the processing is expressed by using a symbol “S”.

First, the start position detection unit 41 (see FIG. 8) determines whether or not a state where a body part remains still continues for a predetermined period or longer (Step 1).

A period for which a negative result is being obtained in Step 1 is a period for which a user is moving the body part to a start position of an operation.

In a case where a positive result is obtained in Step 1, the start position detection unit 41 (see FIG. 8) detects a start position of a motion in relation to the midair image 10 (Step 2). For example, whether or not the body part is outside the midair image 10 (the body part does not overlap the midair image 10), whether or not the body part is inside the midair image 10 (the body part overlaps the midair image 10), and whether or not the body part is in contact with an outer edge of the midair image 10 are detected.

Next, the moving direction detection unit 42 (see FIG. 8) detects a direction of the motion of the body part used for an operation (Step 3).

Upon detection of the start position and the direction of the motion related to an operation, the operation contents deciding unit 43 (see FIG. 8) decides contents of the operation on the basis of the kind of software that outputs the midair image 10, contents displayed as the midair image 10, and the like (Step 4).

When the contents of the operation are decided, processing according to the contents of the operation is performed (Step 5).

For example, the operation contents deciding unit 43 gives a stimulus indicative of receipt of an operation or a stimulus according to the contents of the operation by controlling the midair haptic apparatus 14.

For example, the screen updating unit 44 performs processing according to the contents of the operation on the midair image 10. For example, the screen updating unit 44 changes a display position of the midair image 10 in midair. For example, the screen updating unit 44 enlarges or shrinks a maximum display region of the midair image 10. For example, the screen updating unit 44 locally enlarges or shrinks a partial image (including an object) that constitutes the midair image 10. Alternatively, the screen updating unit 44 deletes a partial image (including an object) or changes an attribute.

### Specific Example of Operation

The following describes specific examples of an operation executed on the basis of a start position of a motion related to an operation, a direction of the motion, and the like.

### Specific Example 1

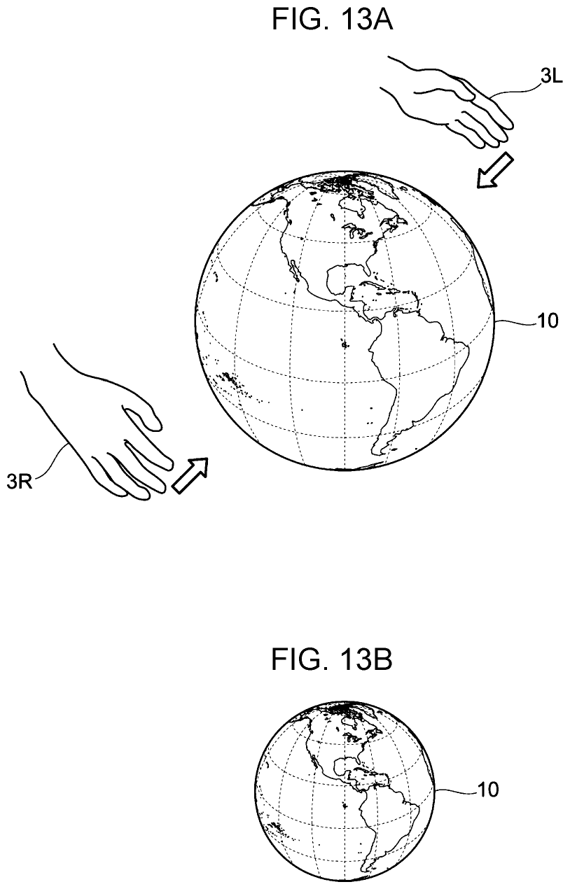

FIGS. 13A and 13B are views for explaining the specific example 1 of an operation using a gesture. FIG. 13A illustrates a positional relationship between operating hands (the right hand 3R and the left hand 3L) and the midair image 10, and FIG. 13B illustrates the midair image 10 displayed after an operation is received.

In the case of FIGS. 13A and 13B, an image of the earth is displayed as the midair image 10.

In the case of FIGS. 13A and 13B, the user's right hand 3R and left hand 3L are moved toward each other from a state where the right hand 3R and the left hand 3L are located outside the midair image 10.

In this case, a maximum display region of the midair image 10 is uniformly shrunk. Needless to say, the image of the earth is also uniformly shrunk in accordance with shrinking of the maximum display region.

This specific example corresponds to the combination 1 of FIG. 10.

### Specific Example 2

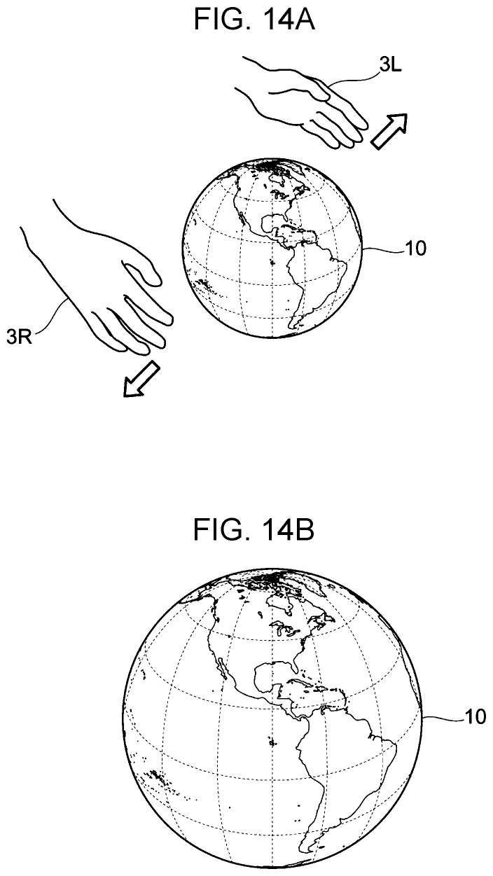

FIGS. 14A and 14B are views for explaining the specific example 2 of an operation using a gesture. FIG. 14A illustrates a positional relationship between operating hands (the right hand 3R and the left hand 3L) and the midair image 10, and FIG. 14B illustrates the midair image 10 displayed after an operation is received.

In the case of FIGS. 14A and 14B, an image of the earth is displayed as the midair image 10.

In the case of FIGS. 14A and 14B, the user's right hand 3R and left hand 3L are moved away from each other from a state where the right hand 3R and the left hand 3L are located outside the midair image 10.

In this case, a maximum display region of the midair image 10 is uniformly enlarged. Needless to say, the image of the earth is also uniformly enlarged in accordance with enlarging of the maximum display region.

This specific example corresponds to the combination 2 of FIG. 10.

### Specific Example 3

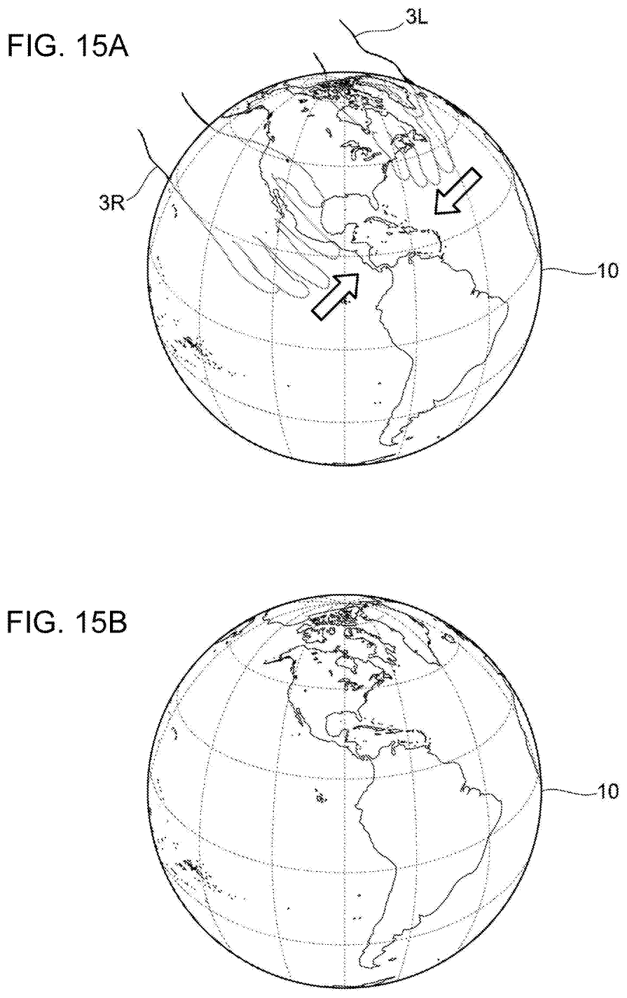

FIGS. 15A and 15B are views for explaining the specific example 3 of an operation using a gesture. FIG. 15A illustrates a positional relationship between operating hands (the right hand 3R and the left hand 3L) and the midair image 10, and FIG. 15B illustrates the midair image 10 displayed after an operation is received.

In the case of FIGS. 15A and 15B, an image of the earth is displayed as the midair image 10.

In the case of FIGS. 15A and 15B, the user's right hand 3R and left hand 3L are moved toward each other from a state where the right hand 3R and the left hand 3L are located inside the midair image 10. The right hand 3R and the left hand 3L can be inserted into the midair image 10 since the midair image 10 is an image that is optically formed in midair as described earlier.

In the case of FIGS. 15A and 15B, the North American continent is sandwiched between the right hand 3R and the left hand 3L.

In this case, the maximum display region of the midair image 10 is not changed, but the image of the North American continent is locally shrunk. An image of a part surrounding the North American continent is deformed so as to be enlarged in association with shrinking of the North American continent. For example, a space closer to the North American continent that is deformed so as to shrink is deformed more so as to be enlarged.

This specific example corresponds to the combination 3 of FIG. 10.

### Specific Example 4

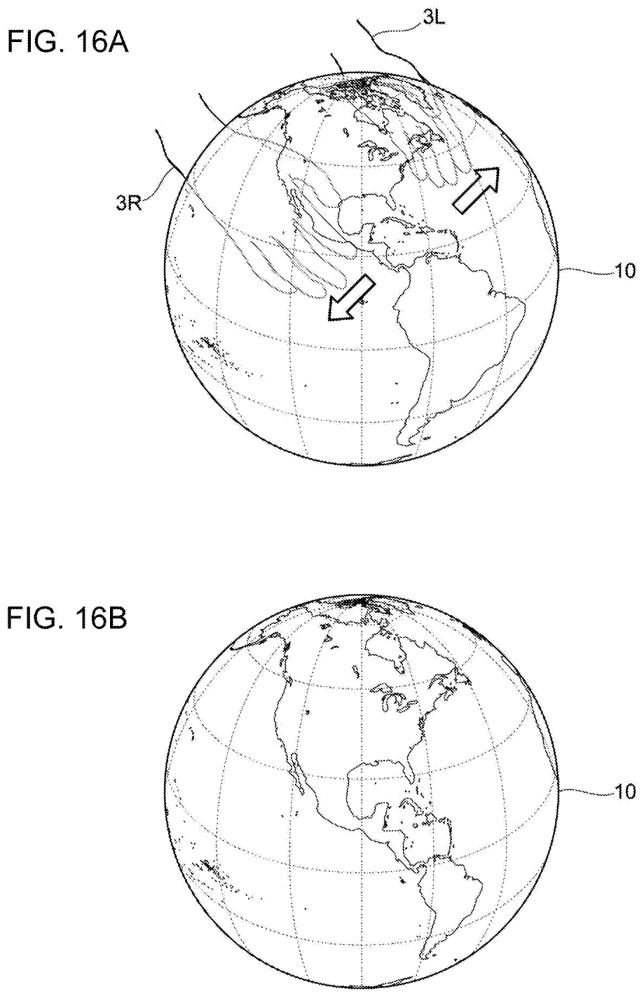

FIGS. 16A and 16B are views for explaining the specific example 4 of an operation using a gesture. FIG. 16A illustrates a positional relationship between operating hands (the right hand 3R and the left hand 3L) and the midair image 10, and FIG. 16B illustrates the midair image 10 displayed after an operation is received.

In the case of FIGS. 16A and 16B, an image of the earth is displayed as the midair image 10.

In the case of FIGS. 16A and 16B, the user's right hand 3R and left hand 3L are moved away from each other from a state where the right hand 3R and the left hand 3L are located inside the midair image 10.

In the case of FIGS. 16A and 16B, the North American continent is sandwiched between the right hand 3R and the left hand 3L.

In this case, the maximum display region of the midair image 10 is not changed, but the image of the North American continent is locally enlarged. An image of a part surrounding the North American continent is deformed so as to shrink in association with enlarging of the North American continent. For example, a space closer to the North American continent that is deformed so as to be enlarged is deformed more so as to shrink.

This specific example corresponds to the combination 4 of FIG. 10.

### Specific Example 5

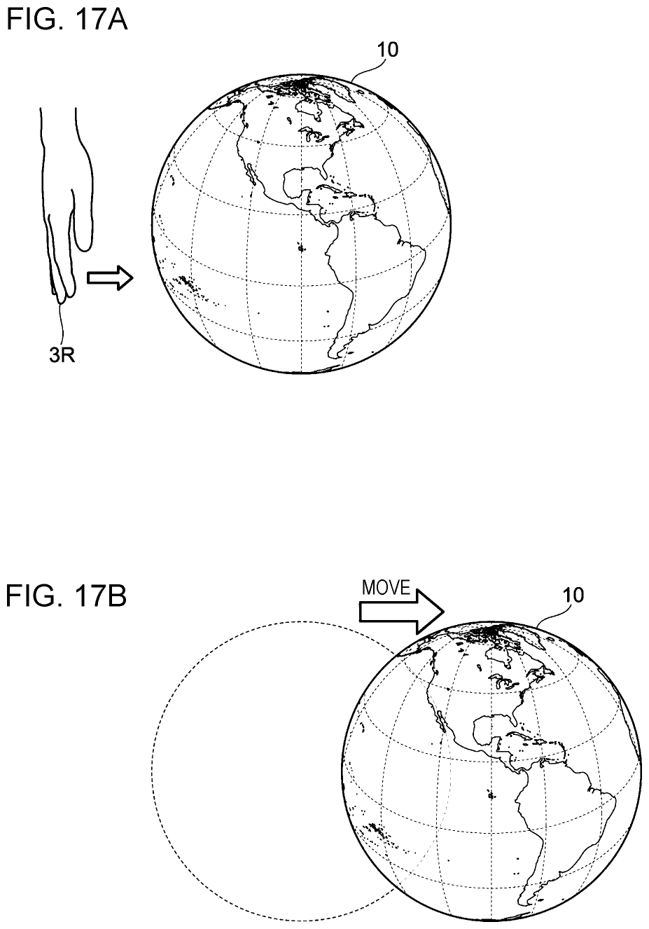

FIGS. 17A and 17B are views for explaining the specific example 5 of an operation using a gesture. FIG. 17A illustrates a positional relationship between an operating hand (the right hand 3R) and the midair image 10, and FIG. 17B illustrates the midair image 10 displayed after an operation is received.

In the case of FIGS. 17A and 17B, an image of the earth is displayed as the midair image 10.

In the case of FIGS. 17A and 17B, the user's right hand 3R is moved toward the midair image 10 from a state where the right hand 3R is located outside the midair image 10. In other words, the right hand 3R is moved rightward from a left side of the midair image 10 in FIG. 17.

In this case, a dimension of the maximum display region of the midair image 10 is not changed, but the position of the midair image 10 is moved in a direction in which the right hand 3R is moved.

This specific example corresponds to the combination 5 of FIG. 10.

### Specific Example 6

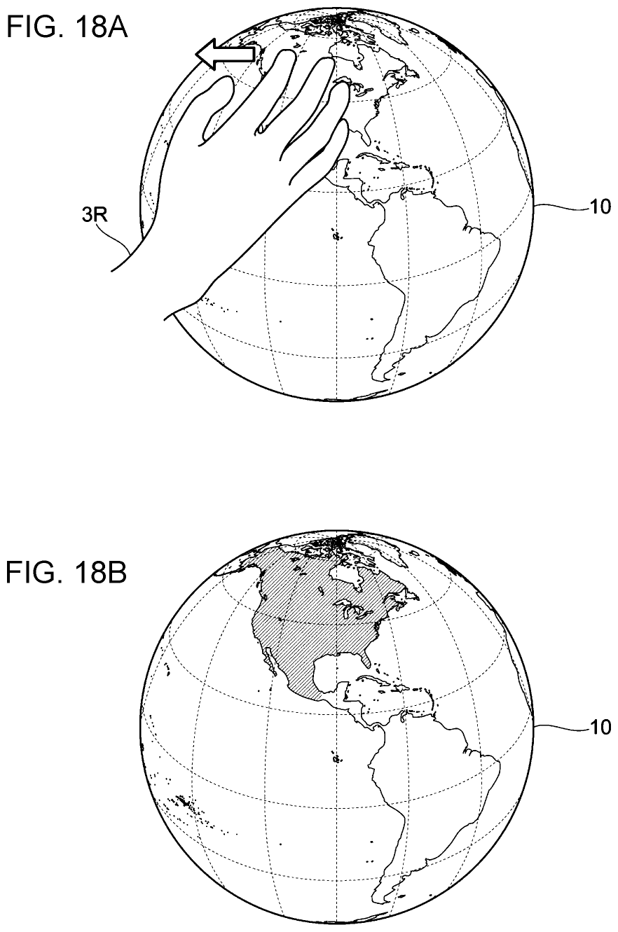

FIGS. 18A and 18B are views for explaining the specific example 6 of an operation using a gesture. FIG. 18A illustrates a positional relationship between an operating hand (the right hand 3R) and the midair image 10, and FIG. 18B illustrates the midair image 10 displayed after an operation is received.

In the case of FIGS. 18A and 18B, an image of the earth is displayed as the midair image 10.

In the case of FIGS. 18A and 18B, the user's right hand 3R is located inside the midair image 10 and is moved so as to slide on the North American continent.

In this case, the dimension of the maximum display region of the midair image 10 and the position of the midair image 10 are not changed, but a color of the displayed North American continent is changed.

This specific example corresponds to the combination 8 of FIG. 10.

In a case where an object displayed as the midair image 10 is a character in a video game, offensive force of the character may be increased by the same operation. When the offensive force is increased, the character may evolve or equipment of the character may be strengthened.

### Specific Example 7

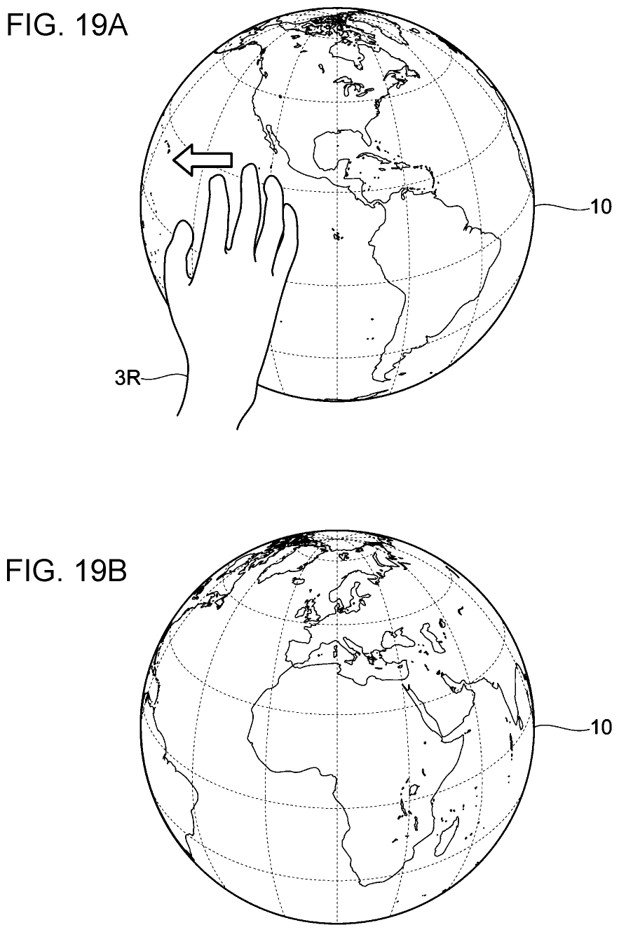

FIGS. 19A and 19B are views for explaining the specific example 7 of an operation using a gesture. FIG. 19A illustrates a positional relationship between an operating hand (the right hand 3R) and the midair image 10, and FIG. 19B illustrates the midair image 10 displayed after an operation is received.

In the case of FIGS. 19A and 19B, an image of the earth is displayed as the midair image 10.

In the case of FIGS. 19A and 19B, the user's right hand 3R is located on the outer edge (circumferential surface) of the midair image 10 and is moved along the outer edge.

In this case, the dimension of the maximum display region of the midair image 10 and the position of the midair image 10 are not changed, but the continents are rotated in a direction in which the right hand 3R is moved. In the case of FIGS. 19A and 19B, a continent seen from the user changes to the African continent and the Eurasia continent as a result of the operation.

This specific example corresponds to the combination 11 of FIG. 10.

In a case where an object displayed as the midair image 10 is a character in a video game, the character may be turned from front view to back view.

### Specific Example 8

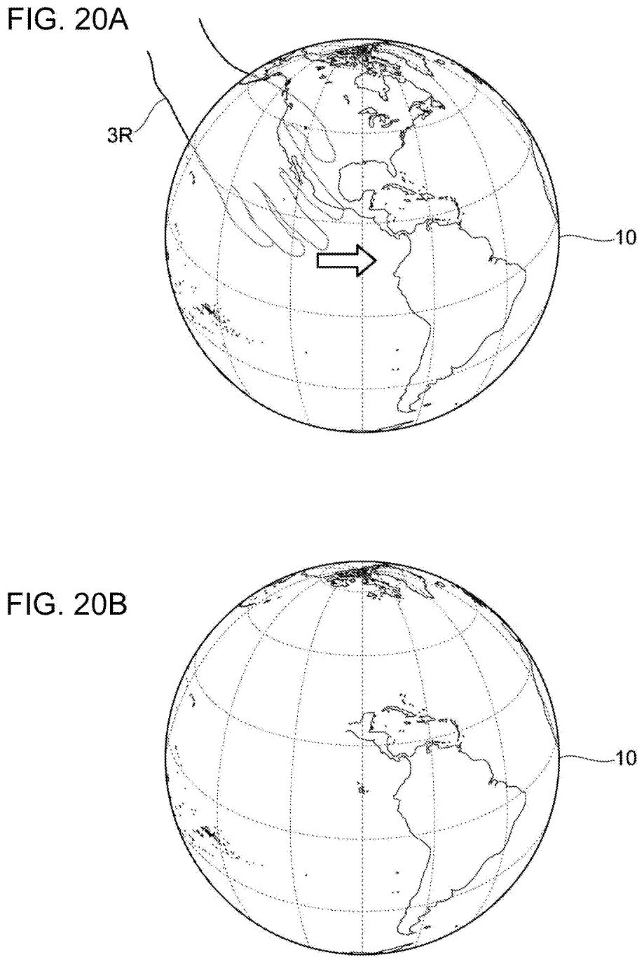

FIGS. 20A and 20B are views for explaining the specific example 8 of an operation using a gesture. FIG. 20A illustrates a positional relationship between an operating hand (the right hand 3R) and the midair image 10, and FIG. 20B illustrates the midair image 10 displayed after an operation is received.

In the case of FIGS. 20A and 20B, an image of the earth is displayed as the midair image 10.

In the case of FIGS. 20A and 20B, the user's right hand 3R is located inside the midair image 10 and is moved so as to slide on the midair image 10 in this state.

In this case, the North American continent on which the right hand 3R is moved is deleted.

This specific example corresponds to the combination 8 of FIG. 11.

### Specific Example 9

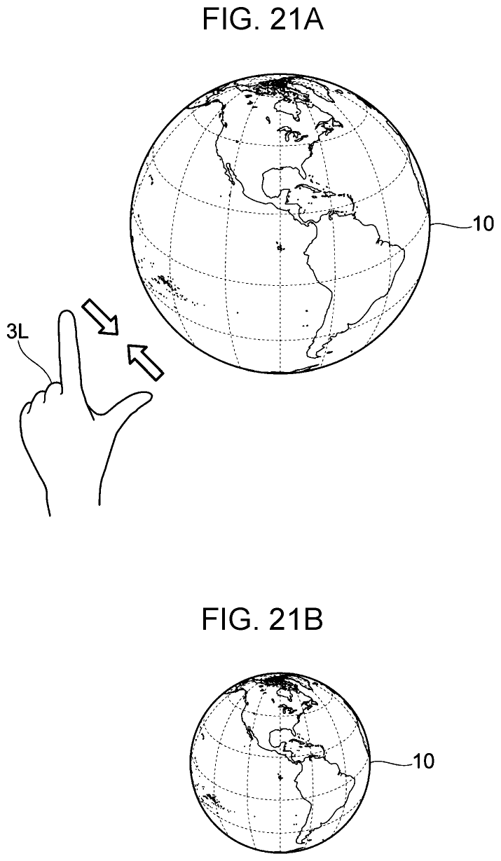

FIGS. 21A and 21B are views for explaining the specific example 9 of an operation using a gesture. FIG. 21A illustrates a positional relationship between an operating hand (the left hand 3L) and the midair image 10, and FIG. 21B illustrates the midair image 10 displayed after an operation is received.

In the case of FIGS. 21A and 21B, an image of the earth is displayed as the midair image 10.

In the case of FIGS. 21A and 21B, the user's left hand 3L is located outside the midair image 10, and the thumb and the forefinger are moved toward each other in this state.

In this case, the maximum display region of the midair image 10 is uniformly shrunk. Needless to say, the image of the earth is also uniformly shrunk in association with shrinking of the maximum display region.

This specific example corresponds to the combination 6 of FIG. 10.

### Specific Example 10

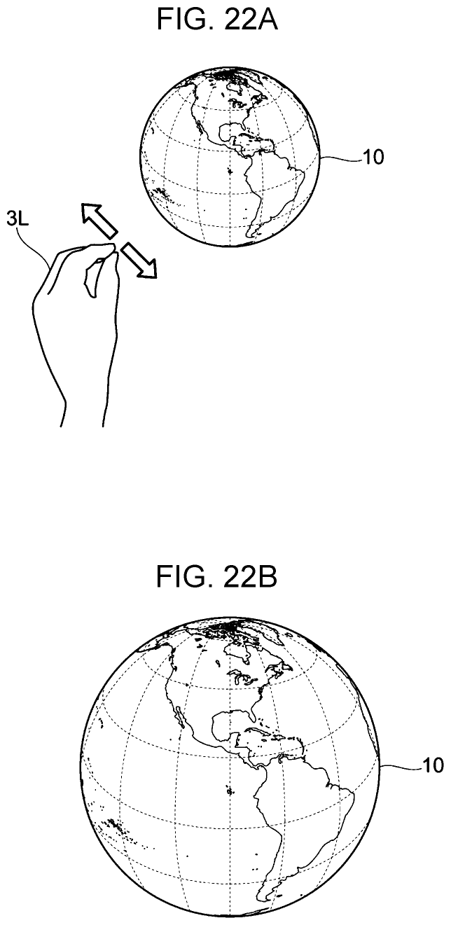

FIGS. 22A and 22B are views for explaining the specific example 10 of an operation using a gesture. FIG. 22A illustrates a positional relationship between an operating hand (the left hand 3L) and the midair image 10, and FIG. 22B illustrates the midair image 10 displayed after an operation is received.

In the case of FIGS. 22A and 22B, an image of the earth is displayed as the midair image 10.

In the case of FIGS. 22A and 22B, the user's left hand 3L is located outside the midair image 10, and the thumb and the forefinger are moved away from each other in this state.

In this case, the maximum display region of the midair image 10 is uniformly enlarged. Needless to say, the image of the earth is also uniformly enlarged in association with enlarging of the maximum display region.

This specific example corresponds to the combination 7 of FIG. 10.

### Specific Example 11

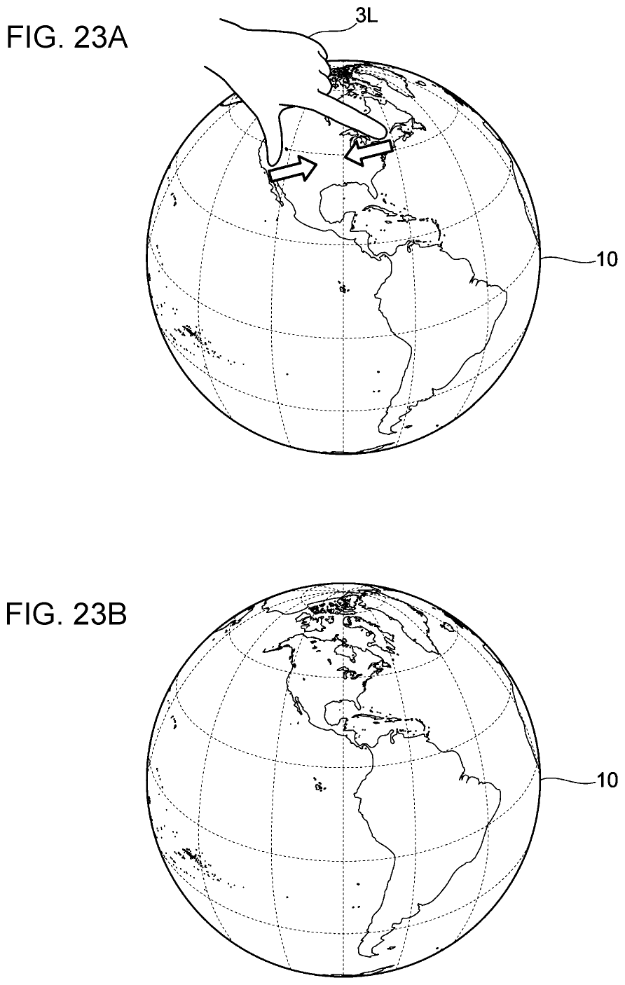

FIGS. 23A and 23B are views for explaining the specific example 11 of an operation using a gesture. FIG. 23A illustrates a positional relationship between an operating hand (the left hand 3L) and the midair image 10, and FIG. 23B illustrates the midair image 10 displayed after an operation is received.

In the case of FIGS. 23A and 23B, an image of the earth is displayed as the midair image 10.

In the case of FIGS. 23A and 23B, the user's left hand 3L is located inside the midair image 10, and the thumb and the forefinger are moved toward each other in this state.

In the case of FIGS. 23A and 23B, the North American continent is sandwiched between the thumb and the fore finger of the left hand 3L.

In this case, the maximum display region of the midair image 10 is not changed, but the image of the North American continent is locally shrunk. An image of a part surrounding the North American continent is deformed so as to be enlarged in association with shrinking of the North American continent. For example, a space closer to the North American continent that is deformed so as to shrink is deformed more so as to be enlarged.

This specific example corresponds to the combination 10 of FIG. 10.

### Specific Example 12

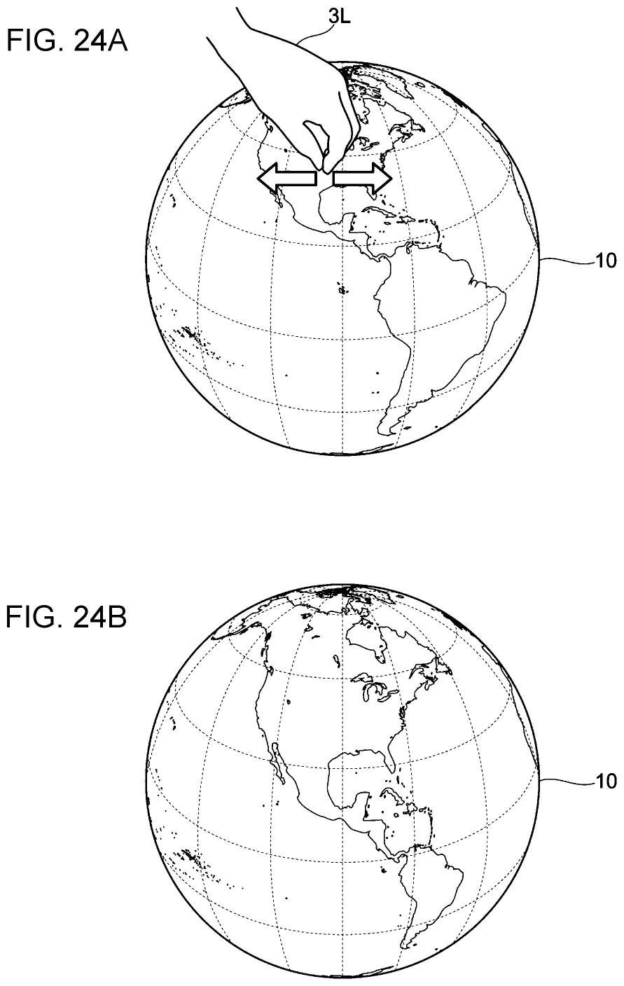

FIGS. 24A and 24B are views for explaining the specific example 12 of an operation using a gesture. FIG. 24A illustrates a positional relationship between an operating hand (the left hand 3L) and the midair image 10, and FIG. 24B illustrates the midair image 10 displayed after an operation is received.

In the case of FIGS. 24A and 24B, an image of the earth is displayed as the midair image 10.

In the case of FIGS. 24A and 24B, the user's left hand 3L is located inside the midair image 10, and the thumb and the forefinger are moved away from each other in this state.

In the case of FIGS. 24A and 24B, a part of the North American continent is sandwiched between the thumb and the fore finger of the left hand 3L.

In this case, the maximum display region of the midair image 10 is not changed, but the image of the North American continent is locally enlarged. An image of a part surrounding the North American continent is deformed so as to shrink in association with enlarging of the North American continent. For example, a space closer to the North American continent that is deformed so as to be enlarged is deformed more so as to shrink.

This specific example corresponds to the combination 9 of FIG. 10.

### Specific Example 13

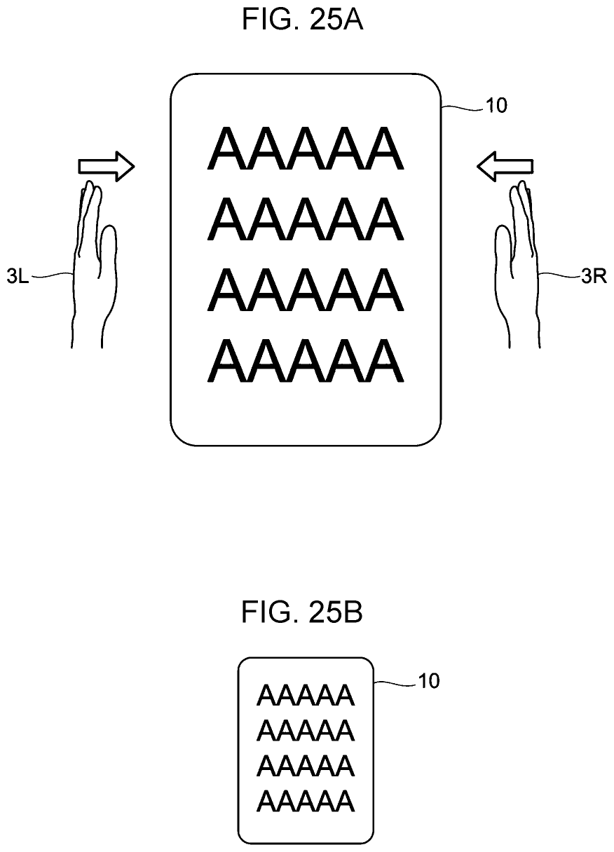

FIGS. 25A and 25B are views for explaining the specific example 13 of an operation using a gesture. FIG. 25A illustrates a positional relationship between operating hands (the right hand 3R and the left hand 3L) and the midair image 10, and FIG. 25B illustrates the midair image 10 displayed after an operation is received.

In FIGS. 25A and 25B, an image of a document “AAAAA/AAAAA/AAAAA/AAAAA” is displayed as the midair image 10. The diagonal lines each means linefeed.

In the case of FIGS. 25A and 25B, the user's right hand 3R and left hand 3L are moved toward each other from a state where the right hand 3R and the left hand 3L are located outside the midair image 10.

In this case, the maximum display region of the midair image 10 is uniformly shrunk. Needless to say, a displayed image of a document is also uniformly shrunk in accordance with shrinking of the maximum display region. Specifically, a size of a font is shrunk. In a case where the document includes an illustration and a figure, the illustration and the figure are also uniformly shrunk.

This specific example corresponds to the combination 1 of FIG. 11.

### Specific Example 14

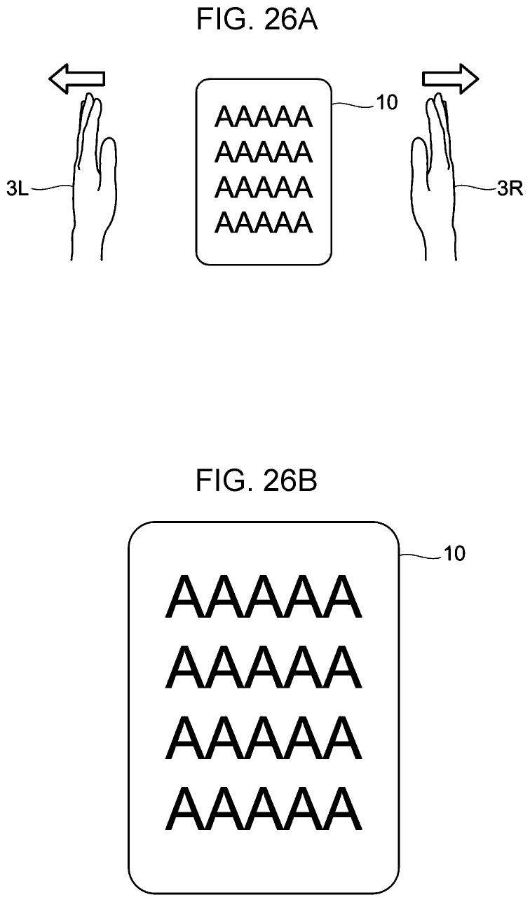

FIGS. 26A and 26B are views for explaining the specific example 14 of an operation using a gesture. FIG. 26A illustrates a positional relationship between operating hands (the right hand 3R and the left hand 3L) and the midair image 10, and FIG. 26B illustrates the midair image 10 displayed after an operation is received.

In the case of FIGS. 26A and 26B, a document (AAAAA/AAAAA/AAAAA/AAAAA) is displayed as the midair image 10.

In the case of FIGS. 26A and 26B, the user's right hand 3R and left hand 3L are moved away from each other from a state where the right hand 3R and the left hand 3L are located outside the midair image 10.

In this case, the maximum display region of the midair image 10 is uniformly enlarged. Needless to say, a displayed image of a document is also uniformly enlarged in accordance with enlarging of the maximum display region. Specifically, a size of a font is enlarged. In a case where the document includes an illustration and a figure, the illustration and the figure are also uniformly enlarged.

This specific example corresponds to the combination 2 of FIG. 11.

### Specific Example 15

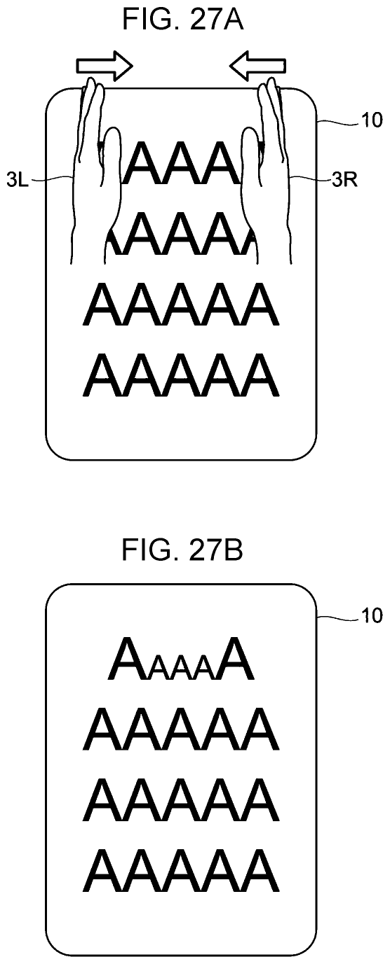

FIGS. 27A and 27B are views for explaining the specific example 15 of an operation using a gesture. FIG. 27A illustrates a positional relationship between operating hands (the right hand 3R and the left hand 3L) and the midair image 10, and FIG. 27B illustrates the midair image 10 displayed after an operation is received.

In the case of FIGS. 27A and 27B, a document (AAAAA/AAAAA/AAAAA/AAAAA) is displayed as the midair image 10.

In the case of FIGS. 27A and 27B, the user's right hand 3R and left hand 3L are moved toward each other from a state where the right hand 3R and the left hand 3L are located inside the midair image 10.

In the case of FIGS. 27A and 27B, middle three characters (AAA) of a top character string (AAAAA) are sandwiched between the right hand 3R and the left hand 3L.

In this case, the maximum display region of the midair image 10 is not changed, but the middle three characters of the top character string are locally shrunk. In the case of FIGS. 27A and 27B, the other characters of the top character string and the second and subsequent character strings from the top are not changed.

Alternatively, an image of a part surrounding the middle three characters of the top character string may be deformed so as to be enlarged in association with shrinking of the character string. In this case, an image closer to the character string that is deformed so as to shrink may be deformed more so as to be enlarged.

This specific example corresponds to the combination 3 of FIG. 11.

### Specific Example 16

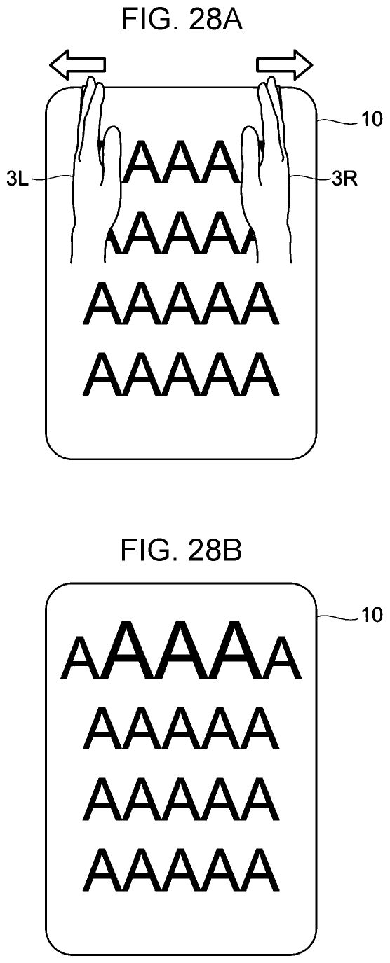

FIGS. 28A and 28B are views for explaining the specific example 16 of an operation using a gesture. FIG. 28A illustrates a positional relationship between operating hands (the right hand 3R and the left hand 3L) and the midair image 10, and FIG. 28B illustrates the midair image 10 displayed after an operation is received.

In the case of FIGS. 28A and 28B, a document (AAAAA/AAAAA/AAAAA/AAAAA) is displayed as the midair image 10.

In the case of FIGS. 28A and 28B, the user's right hand 3R and left hand 3L are moved away from each other from a state where the right hand 3R and the left hand 3L are located inside the midair image 10.

In the case of FIGS. 28A and 28B, middle three characters (AAA) of a top character string (AAAAA) are sandwiched between the right hand 3R and the left hand 3L.

In this case, the maximum display region of the midair image 10 is not changed, but the middle three characters of the top character string are locally enlarged. In the case of FIGS. 28A and 28B, the other characters of the top character string and the second and subsequent character strings from the top are not changed.

Alternatively, an image of a part surrounding the middle three characters of the top character string may be deformed so as to shrink in association with enlarging of the character string. In this case, an image closer to the character string that is deformed so as to be enlarged may be deformed more so as to shrink.

This specific example corresponds to the combination 4 of FIG. 11.

### Specific Example 17

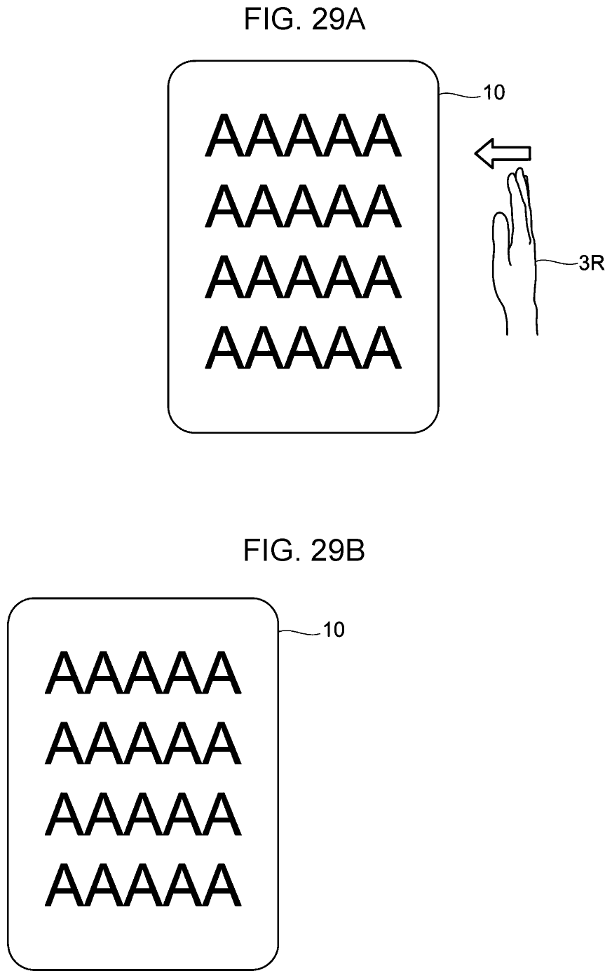

FIGS. 29A and 29B are views for explaining the specific example 16 of an operation using a gesture. FIG. 29A illustrates a positional relationship between an operating hand (the right hand 3R) and the midair image 10, and FIG. 29B illustrates the midair image 10 displayed after an operation is received.

In the case of FIGS. 29A and 29B, a document (AAAAA/AAAAA/AAAAA/AAAAA) is displayed as the midair image 10.

In the case of FIGS. 29A and 29B, the user's right hand 3R is moved toward the midair image 10 from a state where the right hand 3R is located outside the midair image 10. In other words, the right hand 3R is moved leftward from a right side of the midair image 10 in FIGS. 29A and 29B.

In this case, a dimension of the maximum display region of the midair image 10 is not changed, but the position of the midair image 10 is moved in a direction in which the right hand 3R is moved.

This specific example corresponds to the combination 5 of FIG. 11.

### Specific Example 18

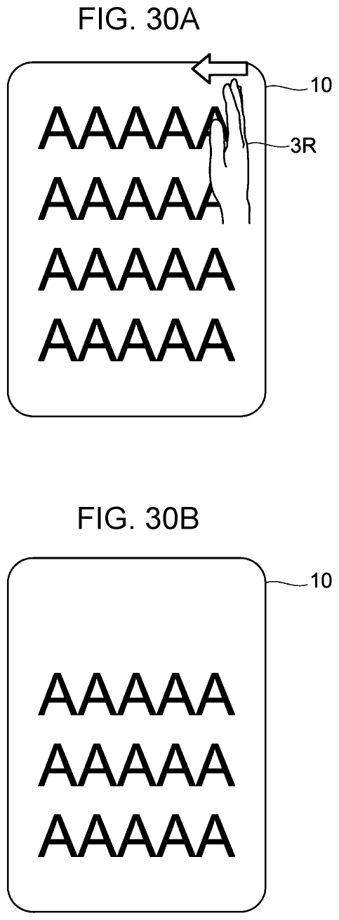

FIGS. 30A and 30B are views for explaining the specific example 18 of an operation using a gesture. FIG. 30A illustrates a positional relationship between an operating hand (the right hand 3R) and the midair image 10, and FIG. 30B illustrates the midair image 10 displayed after an operation is received.

In the case of FIGS. 30A and 30B, a document (AAAAA/AAAAA/AAAAA/AAAAA) is displayed as the midair image 10.

In the case of FIGS. 30A and 30B, the user's right hand 3R is located inside the midair image 10 and is moved so as to slide on a top character string (AAAAA).

In this case, a dimension of the maximum display region of the midair image 10 is not changed, but a character string displayed in a place where the right hand 3R is moved is deleted.

This specific example corresponds to the combination 8 of FIG. 11.

### Specific Example 19

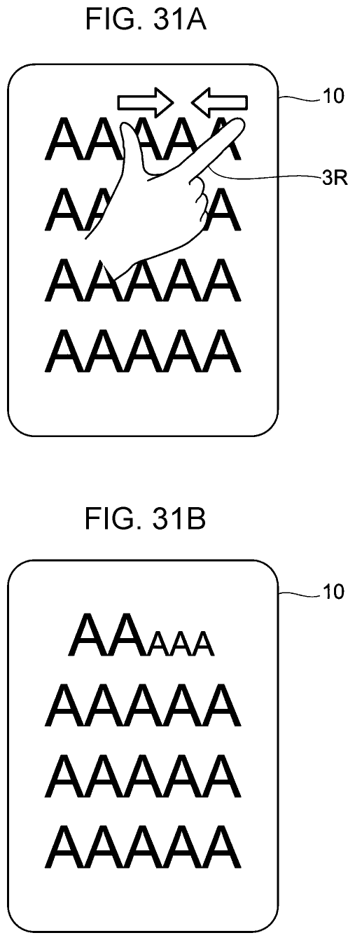

FIGS. 31A and 31B are views for explaining the specific example 19 of an operation using a gesture. FIG. 31A illustrates a positional relationship between an operating hand (the right hand 3R) and the midair image 10, and FIG. 31B illustrates the midair image 10 displayed after an operation is received.

In the case of FIGS. 31A and 31B, a document (AAAAA/AAAAA/AAAAA/AAAAA) is displayed as the midair image 10.

In the case of FIGS. 31A and 31B, the user's right hand 3R is located inside the midair image 10, and the thumb and the forefinger are moved toward each other in this state.

In the case of FIGS. 31A and 31B, three characters (AAA) on a right side of the top character string (AAAAA) are sandwiched between the thumb and the forefinger of the right hand 3R.

In this case, the maximum display region of the midair image 10 is not changed, but the characters on the right side of the top character string are locally shrunk. In the case of FIGS. 31A and 31B, the other characters of the top character string and the second and subsequent character strings are not changed.

Alternatively, an image of a part surrounding the characters may be deformed so as to be enlarged in association with shrinking of the character string. In this case, an image closer to the character string that is deformed so as to shrink may be deformed more so as to be enlarged.

This specific example corresponds to the combination 11 of FIG. 11.

### Specific Example 20

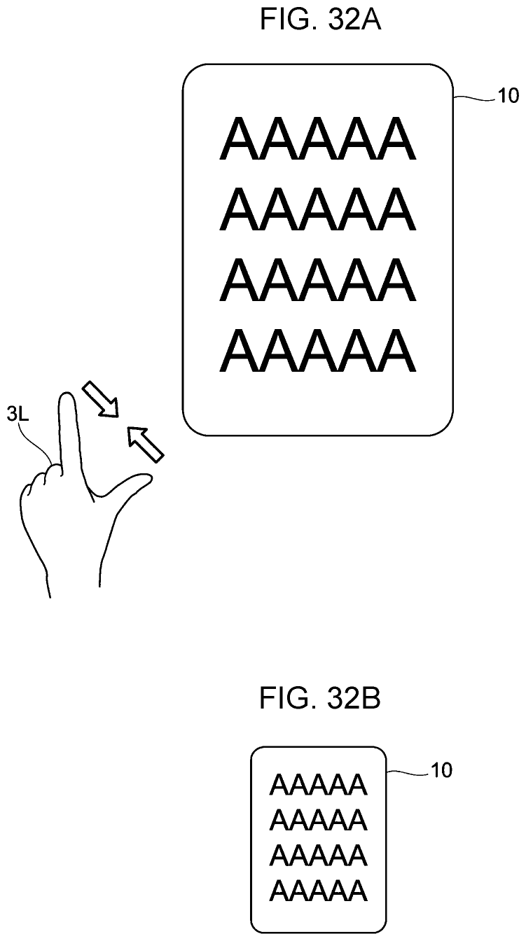

FIGS. 32A and 32B are views for explaining the specific example 20 of an operation using a gesture. FIG. 32A illustrates a positional relationship between an operating hand (the left hand 3L) and the midair image 10, and FIG. 32B illustrates the midair image 10 displayed after an operation is received.

In the case of FIGS. 32A and 32B, a document (AAAAA/AAAAA/AAAAA/AAAAA) is displayed as the midair image 10.

In the case of FIGS. 32A and 32B, the user's left hand 3L is located outside the midair image 10, and the thumb and the forefinger are moved toward each other in this state.

In this case, the maximum display region of the midair image 10 is uniformly shrunk. Needless to say, a displayed image of a document is also uniformly shrunk in accordance with shrinking of the maximum display region. Specifically, a size of a font is shrunk. In a case where the document includes an illustration and a figure, the illustration and the figure are also uniformly shrunk.

This specific example corresponds to the combination 6 of FIG. 11.

### Specific Example 21

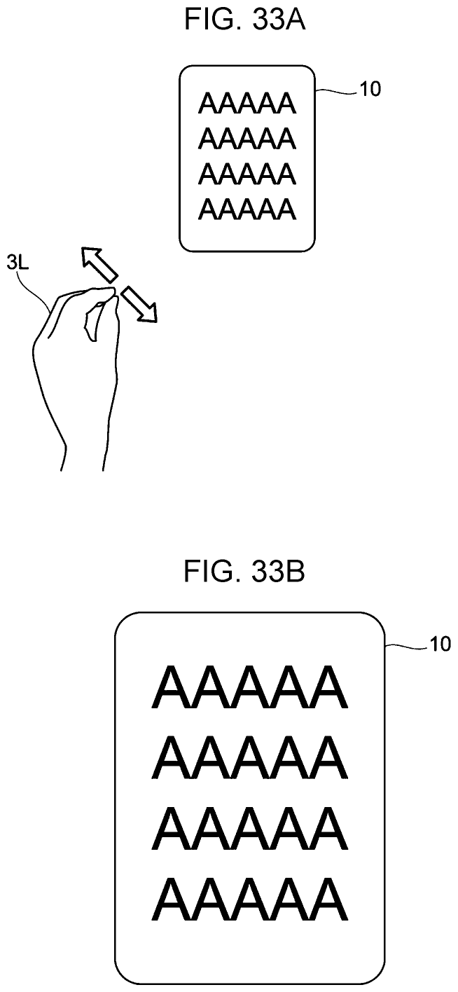

FIGS. 33A and 33B are views for explaining the specific example 21 of an operation using a gesture. FIG. 33A illustrates a positional relationship between an operating hand (the left hand 3L) and the midair image 10, and FIG. 33B illustrates the midair image 10 displayed after an operation is received.

In the case of FIGS. 33A and 33B, a document (AAAAA/AAAAA/AAAAA/AAAAA) is displayed as the midair image 10.

In the case of FIGS. 33A and 33B, the user's left hand 3L is located outside the midair image 10, and the thumb and the forefinger are moved away from each other in this state.

In this case, the maximum display region of the midair image 10 is uniformly enlarged. Needless to say, a displayed image of a document is also uniformly enlarged in accordance with enlarging of the maximum display region. Specifically, a size of a font is enlarged. In a case where the document includes an illustration and a figure, the illustration and the figure are also uniformly enlarged.

This specific example corresponds to the combination 7 of FIG. 11.

### Specific Example 22

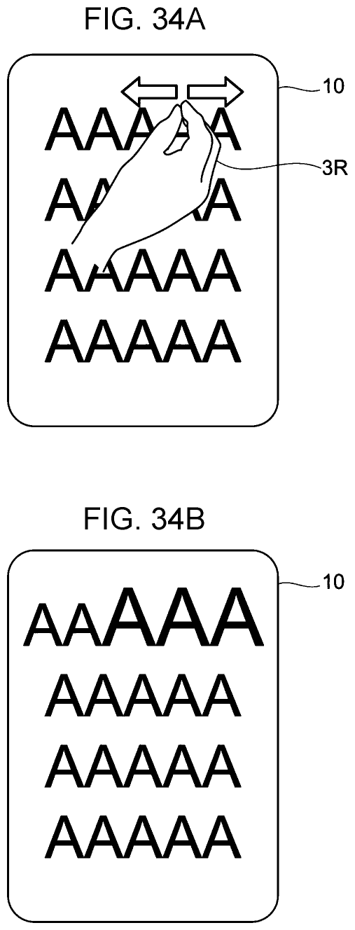

FIGS. 34A and 34B are views for explaining the specific example 22 of an operation using a gesture. FIG. 34A illustrates a positional relationship between an operating hand (the right hand 3R) and the midair image 10, and FIG. 34B illustrates the midair image 10 displayed after an operation is received.

In the case of FIGS. 34A and 34B, a document (AAAAA/AAAAA/AAAAA/AAAAA) is displayed as the midair image 10.

In the case of FIGS. 34A and 34B, the user's right hand 3R is located inside the midair image 10, and the thumb and the forefinger are moved away from each other in this state.

In the case of FIGS. 34A and 34B, three characters (AAA) on a right side of the top character string (AAAAA) are sandwiched between the thumb and the forefinger of the right hand 3R.

In this case, the maximum display region of the midair image 10 is not changed, but the three characters on the right side of the top character string are locally enlarged. In the case of FIGS. 34A and 34B, the other characters of the top character string and the second and subsequent character strings are not changed.

Alternatively, an image of a part surrounding the characters may be deformed so as to shrink in association with enlarging of the character string. In this case, an image closer to the character string that is deformed so as to be enlarged may be deformed more so as to shrink.

This specific example corresponds to the combination 10 of FIG. 11.

### Specific Example 23

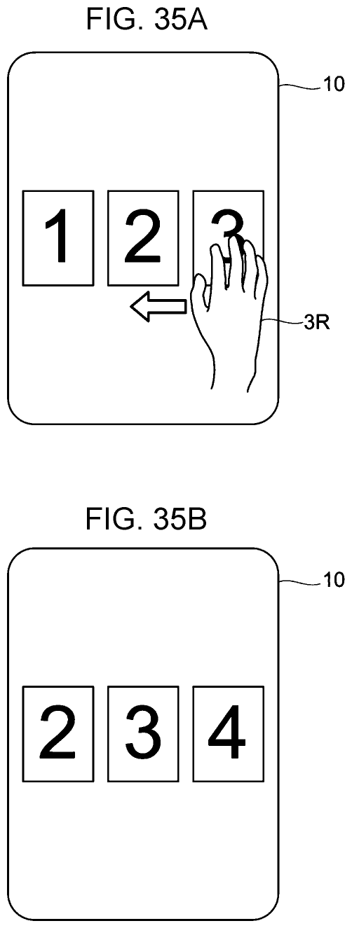

FIGS. 35A and 35B are views for explaining the specific example 23 of an operation using a gesture. FIG. 35A illustrates a positional relationship between an operating hand (the right hand 3R) and the midair image 10, and FIG. 35B illustrates the midair image 10 displayed after an operation is received.

In the case of FIGS. 35A and 35B, images of plural pages are displayed as the midair image 10. Specifically, images of pages 1, 2, and 3 are displayed from a left side to a right side.

In the case of FIGS. 35A and 35B, the user's right hand 3R is located inside the midair image 10 and is moved leftward so as to slide on the images.

In this case, the maximum display region of the midair image 10 is not changed, but the pages displayed as the midair image 10 are changed. Specifically, images of pages 2, 3, and 4 are displayed from a left side to a right side. This operation corresponds to page turning for turning displayed pages forward.

This specific example corresponds to the combination 9 of FIG. 11.

### Specific Example 24

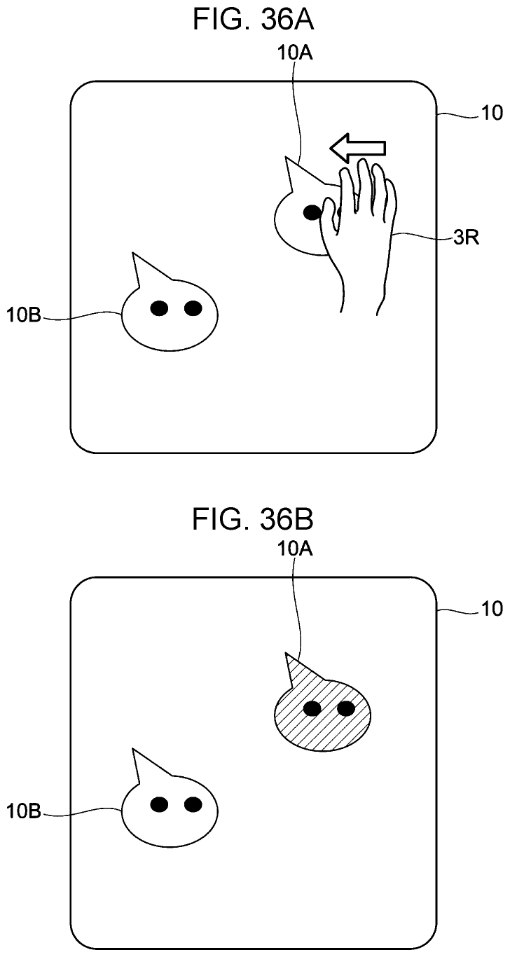

FIGS. 36A and 36B are views for explaining the specific example 24 of an operation using a gesture. FIG. 36A illustrates a positional relationship between an operating hand (the right hand 3R) and the midair image 10, and FIG. 36B illustrates the midair image 10 displayed after an operation is received.

In the case of FIGS. 36A and 36B, the midair image 10 including game characters 10A and 10B is displayed.

The specific example 23 is a case where the midair image 10 is output from software for drawing as in the specific examples 1 through 12.

In the case of FIGS. 36A and 36B, the user's right hand 3R is located inside the midair image 10 and is moved so as to slide on the character 10A located on a right side of FIGS. 36A and 36B.

In this case, the maximum display region of the midair image 10 is not changed, but a color of the character 10A is changed.

This specific example corresponds to the combination 8 of FIG. 10.

### Specific Example 25

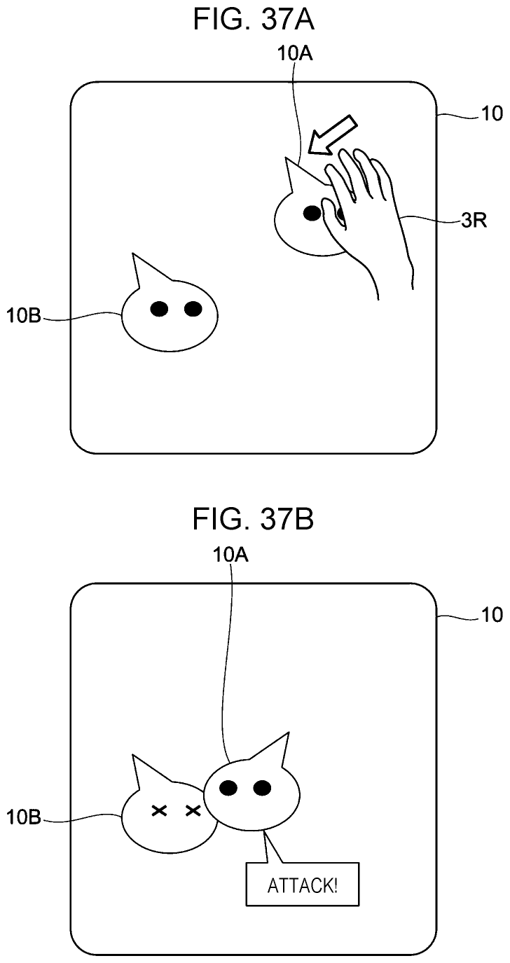

FIGS. 37A and 37B are views for explaining the specific example 25 of an operation using a gesture. FIG. 37A illustrates a positional relationship between an operating hand (the right hand 3R) and the midair image 10, and FIG. 37B illustrates the midair image 10 displayed after an operation is received.

In the case of FIGS. 37A and 37B, the midair image 10 including game characters 10A and 10B is displayed.

In the case of FIGS. 37A and 37B, the user's right hand 3R is located inside the midair image 10 and is moved so as to slide on the character 10A located on a right side of FIGS. 37A and 37B.

However, in the specific example 24, this operation is used to move a display position of the character 10A in the midair image 10.

In the case of FIGS. 37A and 37B, the character 10A attacks the character 10B located at a position to which the character 10A is moved. The expression of the attacked character 10B changes to a painful expression.

### Specific Example 26

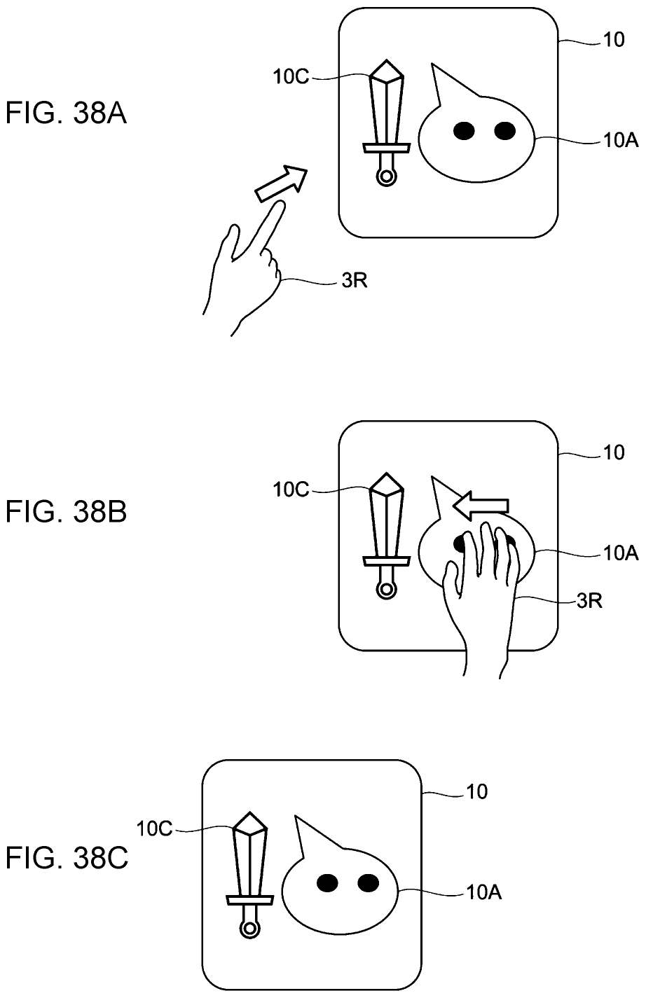

FIGS. 38A through 38C are views for explaining the specific example 26 of an operation using a gesture. FIG. 38A illustrates a positional relationship between an operating hand (the right hand 3R) and the midair image 10, FIG. 38B illustrates an operation on the midair image 10, and FIG. 38C illustrates the midair image 10 displayed after a two-stage operation is received.

In the case of FIGS. 38A through 38C, the midair image 10 including a game character 10A equipped with a sword 10C is displayed.

The example of FIGS. 38A through 38C corresponds to an example in which contents of an operation are switched by combining plural operations.

In the case of FIGS. 38A through 38C, the right hand 3R is located outside the midair image 10. In this state, the right hand 3R is moved toward the midair image 10. This movement alone is not recognized as an operation on the midair image 10, and therefore the midair image 10 is not changed.

Then, the user's right hand 3R is moved to the inside of the midair image 10 and is moved so as to slide on the character 10A. This operation is received as an operation of moving the midair image 10 unlike the specific example 23 (see FIGS. 35A and 35B) and the specific example 24 (see FIGS. 36A and 36B).

### Specific Example 27

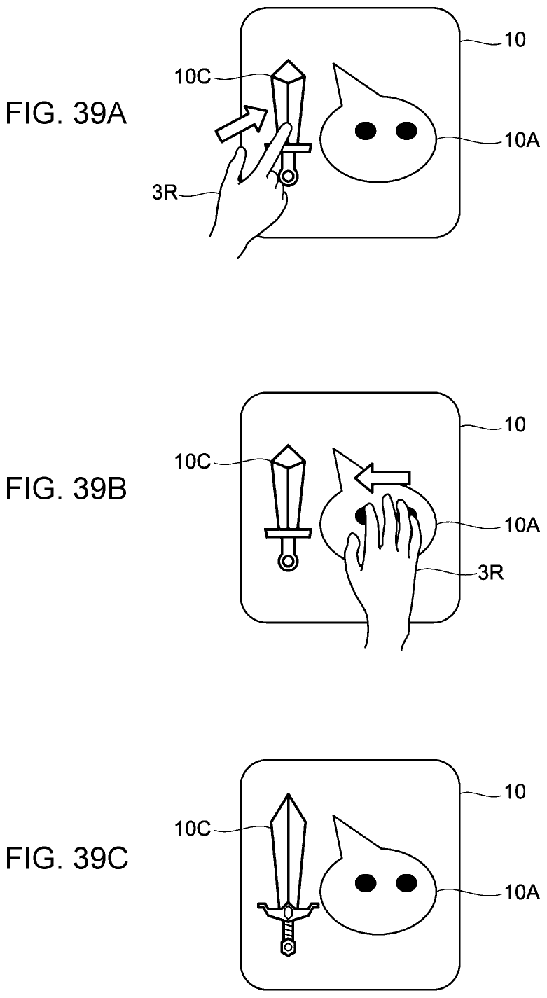

FIGS. 39A through 39C are views for explaining the specific example 27 of an operation using a gesture. FIG. 39A illustrates a positional relationship between an operating hand (the right hand 3R) and the midair image 10, FIG. 39B illustrates an operation on the midair image 10, and FIG. 39C illustrates the midair image 10 displayed after a two-stage operation is received.

In the case of FIGS. 39A through 39C, the midair image 10 including a game character 10A equipped with a sword 10C is displayed.

The example of FIGS. 39A through 39C corresponds to an example in which contents of an operation are switched by combining plural operations.

In the case of FIGS. 39A through 39C, the right hand 3R is located so as to be in contact with the sword 10C or overlap the sword 10C. In this state, the right hand 3R is moved closer to the midair image 10 or inserted into the midair image 10. In the case of FIGS. 39A through 39C, this operation is not recognized as an operation on the midair image 10, and therefore the midair image 10 is not changed at this stage.

Then, the user's right hand 3R is moved to the inside of the midair image 10 and is moved so as to slide on the character 10A. This operation is received as an operation of changing an attribute of the sword 10C.

In the case of FIGS. 39A through 39C, the sword 10C is changed to the sword 10C having increased offensive force.

In the case of FIGS. 39A through 39C, equipment of the character 10A is the sword 10C, but a shield, clothing, shoes, a hat, or the like may be changed every time the operation is received.

### Specific Example 28

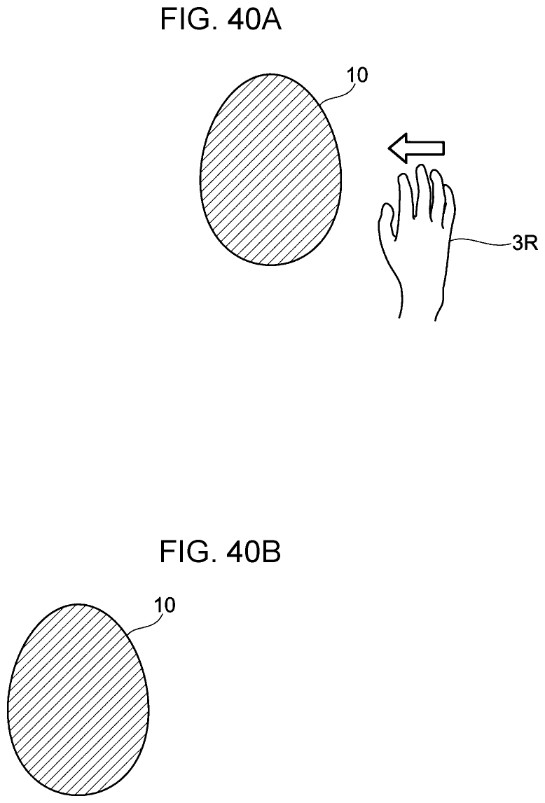

FIGS. 40A and 40B are views for explaining the specific example 28 of an operation using a gesture. FIG. 40A illustrates a positional relationship between an operating hand (the right hand 3R) and the midair image 10, and FIG. 40B illustrates the midair image 10 displayed after an operation is received.

In the case of FIGS. 40A and 40B, the midair image 10 of an egg having three-dimensional data (inner structure data) is displayed.

In the case of FIGS. 40A and 40B, the user's right hand 3R is moved toward the midair image 10 from a state where the right hand 3R is located outside the midair image 10. In other words, the right hand 3R is moved from a right side to a left side of the midair image 10 in FIGS. 40A and 40B.

In this case, a dimension of the maximum display region of the midair image 10 is not changed, but the position of the midair image 10 is moved in a direction in which the right hand 3R is moved.

This specific example is an example of an operation on an outer-layer image.

### Specific Example 29

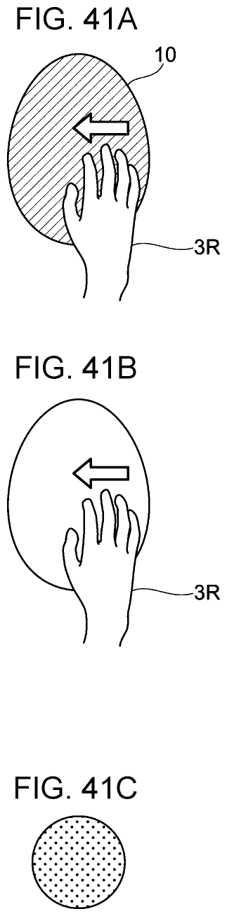

FIGS. 41A through 41C are views for explaining the specific example 29 of an operation using a gesture. FIG. 41A illustrates a positional relationship between an operating hand (the right hand 3R) and the midair image 10, FIG. 41B illustrates the midair image 10 displayed after an operation is received, and FIG. 41C illustrates the midair image 10 after an operation is further received.

In the case of FIGS. 41A through 41C, the midair image 10 of an egg having an inner structure is displayed. Specifically, the egg has a shell as a topmost layer, albumen as an intermediate layer, and yolk as a lowermost layer. These three layers may be displayed concurrently or only a layer designated by a user may be displayed.

In the case of FIGS. 41A through 41C, the user's right hand 3R is in contact with the midair image 10 or located inside the midair image 10.

FIGS. 41A through 41C illustrate a change of the midair image 10 caused in a case where the right hand 3R is moved so as to slide on the midair image 10 in this state.

In the case of FIGS. 41A through 41C, the midair image 10 changes to albumen as a result of the first gesture, and the midair image 10 changes to yolk as a result of the second gesture.

This specific example is an example of an operation on an inside image.

### Other Exemplary Embodiments

The exemplary embodiment of the present disclosure has been described above, but the technical scope of the present disclosure is not limited to the scope described in the exemplary embodiment. It is clear from the recitations of the claims that various changes or modifications of the above exemplary embodiment are also encompassed within the technical scope of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a detection unit that detects a motion of a target to be detected made to an image formed in midair; and
a controller that controls contents of an operation on the image in accordance with a combination of a start position of the motion relative to a display region of the image and a direction of the motion.

2. The information processing apparatus according to claim 1, wherein
the combination is one of a plurality of combinations, and the plurality of combinations are prepared in advance.

3. The information processing apparatus according to claim 2, wherein
the start position of the motion is one or more of a position that does not overlap the image, a position that overlaps the image, a position that is in contact with the image.

4. The information processing apparatus according to claim 1, wherein
contents of the control according to the combination are decided in accordance with an application program used to display the image.

5. The information processing apparatus according to claim 1, wherein
contents of the control according to the combination are decided in accordance with an attribute of an object to be operated.

6. The information processing apparatus according to claim 1, wherein
the start position of the motion is a position at which the target to be detected is regarded to be still for a predetermined period or longer.

7. The information processing apparatus according to claim 1, wherein
the start position of the motion is a position at which passage of the target to be detected is detected within a predetermined region for detection.

8. The information processing apparatus according to claim 1, wherein
in a case where positions of both hands at start of the motion do not overlap the image and the hand are moved away from each other, the controller enlarges a maximum display region of the image.

9. The information processing apparatus according to claim 1, wherein
in a case where positions of both hands at start of the motion overlap the image and the hand are moved away from each other, the controller locally enlarges a part of the image that is sandwiched between the hands within a maximum display region.

10. The information processing apparatus according to claim 1, wherein
in a case where positions of both hands at start of the motion do not overlap the image and the hand are moved toward each other, the controller shrinks a maximum display region of the image as a result of the operation.

11. The information processing apparatus according to claim 1, wherein
in a case where positions of both hands at start of the motion overlap the image and the hand are moved toward each other, the controller locally shrinks a part of the image that is sandwiched between the hands within a maximum display region.

12. The information processing apparatus according to claim 1, wherein
in a case where a position of a single hand at start of the motion does not overlap the image and the single hand is moved in one direction or rotated, the controller moves a space that forms the image in a direction of the motion or rotates the image.

13. The information processing apparatus according to claim 1, wherein
in a case where a position of a single hand at start of the motion overlaps the image and the single hand is moved in one direction, the controller deletes a part which the single hand passes.

14. The information processing apparatus according to claim 1, wherein
in a case where a position of a single hand at start of the motion does not overlap the image and fingers are moved away from each other, the controller enlarges a maximum display region of the image as a result of the operation.

15. The information processing apparatus according to claim 1, wherein
in a case where a position of a single hand at start of the motion overlaps the image and fingers are moved away from each other, the controller locally enlarges a part sandwiched between the fingers within a maximum display region.

16. The information processing apparatus according to claim 1, wherein
in a case where a position of a single hand at start of the motion does not overlap the image and fingers are moved toward each other, the controller shrinks a maximum display region of the image as a result of the operation.

17. The information processing apparatus according to claim 1, wherein
in a case where a position of a single hand at start of the motion overlaps the image and fingers are moved toward each other, the controller locally shrinks a part sandwiched between the fingers within a maximum display region.

18. The information processing apparatus according to claim 1, wherein
the combination is one of a plurality of combinations, and the controller controls the contents of the operation in accordance with the plurality of combinations.

19. The information processing apparatus according to claim 18, wherein
in a case where the image is a stereoscopic image, the controller controls an outer-layer image or an inner image depending on a difference in start position.

20. The information processing apparatus according to claim 1, wherein
a stimulus according to the contents of the operation is given to a part of a user's body.

21. An information processing system comprising:
an image forming unit that forms an image in midair;
a detection unit that detects a motion of a target to be detected made to the image; and
a controller that controls contents of an operation on the image in accordance with a combination of a start position of the motion relative to a display region of the image and a direction of the motion.

22. A non-transitory computer readable medium storing a program causing a computer to execute a process, the process comprising:
detecting a motion of a target to be detected made to an image formed in midair; and
controlling contents of an operation on the image in accordance with a combination of a start position of the motion relative to a display region of the image and a direction of the motion.
